(19) United States
(12) Patent Application Publication
(10) Pub. No.: US 2021/0198543 A1
(43) Pub. Date: Jul. 1, 2021

(54) DAMPING ADHESIVE LAYERS FOR MICROSPEAKER DIAPHRAGMS

(71) Applicant: 3M INNOVATIVE PROPERTIES COMPANY, St. Paul, MN (US)

(72) Inventors: Chao Yang, Shanghai (CN); Christopher B. Walker, JR., St. Paul, MN (US); Daniel J. O'Neal, St. Paul, MN (US)

(21) Appl. No.: 16/754,827

(22) PCT Filed: Jun. 6, 2018
(86) PCT No.: PCT/CN2018/090071

§ 371 Date: Apr. 9, 2020

(30) Foreign Application Priority Data
Oct. 9, 2017 (CN) PCT/CN2017/105346

(51) Int. Cl. C09J 183/04; H04R 7/06; C08K 5/14; C09J 9/00

(52) U.S. Cl. CPC C09J 183/04; H04R 7/06; C08G 77/70; C09J 9/00; C09J 2301/312; C08K 5/14

(57) ABSTRACT

Thin films are provided comprising a damping adhesive comprising a polysiloxane or mixture of polysiloxanes and exhibiting a tan delta of at least 0.42 for every temperature between 20° C. and 250° C. and a tan delta at 250° C. that is no more than 0.20 greater than the minimum tan delta measured in the range of 20° C. to 250° C.; in some cases exhibiting a tan delta of at least 0.42 for every temperature between 20° C. and 200° C. and a tan delta at 200° C. that is no more than 0.08 greater than the minimum tan delta measured in the range of 20° C. to 200° C.; in some cases obtained by crosslinking polysiloxane(s) by e-beam or peroxide. Microspeaker diaphragm materials, subassemblies and transfer tapes comprising such films are also provided.

### FIELD OF THE DISCLOSURE

This disclosure relates to damping adhesive layers for use in sheet materials, such as may be converted into microspeaker diaphragms.

### BACKGROUND OF THE DISCLOSURE

Microspeakers are increasingly common in small electronics such as cell phones, tablets, earbuds, headphones and laptop computers. Microspeaker diaphragms are ideally light weight and very rigid, so as to exhibit pure pistonic motion, and also well damped, to suppress undriven motion or resonances that result in distorted reproduction of sound. In some cases, diaphragm materials are three-layer membranes comprising a damping layer sandwiched between two stiff layers. The damping layer may also function as an adhesive binding the three layers together. In some cases, diaphragm materials comprise five, seven, or more layers, where the layers are alternating stiff and damping layers.

The following references may be relevant to the general field of technology of the present disclosure: U.S. Pat. Nos. 7,569,278; 5,308,887; 5,624,763; 5,464,659; 5,823,301; WO 2008/141004; U.S. Pat. Nos. 9,359,529; 8,173,252; WO 2016/061121; CN 10202238 B; US2014/017491; U.S. Pat. Nos. 5,712,038; 5,695,867; 8,541,481; 9,017,771; 4,678,828; WO 2016/061121; U.S. Pat. No. 5,695,867; CN 102002238 B; U.S. Pat. Nos. 7,726,441; 8,141,676; US 2016/0309260; US 2014/0072163; US 2014/0284135.

Comparative Example CE 17 herein generally relates to U.S. Pat. No. 5,464,659 at col. 17, line 29-col. 18, line 15; Comp. Ex. 5.

Comparative Example CE 25 herein generally relates to U.S. Pat. No. 8,173,252 at col. 20, lines 52-67; Example C-5d.

Comparative Example CE 27 herein generally relates to U.S. Pat. No. 9,359,529 examples employing PSA6574 silicone pressure sensitive adhesive.

### SUMMARY OF THE DISCLOSURE

Briefly, the present disclosure provides films having a thickness of at least 4 microns and less than 60 microns, in some embodiments less than 20 microns, comprising a damping adhesive which comprises a polysiloxane or mixture of polysiloxanes, wherein the damping adhesive exhibits a tan delta of at least 0.42 for every temperature between 20° C. and 250° C., and wherein the damping adhesive exhibits a tan delta at 250° C. that is no more than 0.20 greater than the minimum tan delta measured in the range of 20° C. to 250° C.

In another aspect, the present disclosure provides films having a thickness of at least 4 microns and less than 60 microns, in some embodiments less than 20 microns, comprising a damping adhesive which comprises a polysiloxane or mixture of polysiloxanes, wherein the damping adhesive exhibits a tan delta of at least 0.42 for every temperature between 20° C. and 200° C., and wherein the damping adhesive exhibits a tan delta at 200° C. that is no more than 0.08 greater than the minimum tan delta measured in the range of 20° C. to 200° C.

In another aspect, the present disclosure provides films having a thickness of at least 4 microns and less than 20 microns comprising a damping adhesive, obtained by crosslinking polysiloxane(s) by exposing the polysiloxane(s) in the form of a polysiloxane film having a thickness of greater than 5 microns and less than 60 microns, in some embodiments less than 20 microns, to between 1.5 and 5.5 Mrad of e-beam radiation at a voltage of greater than 150 kV, wherein polysiloxane(s) means a polysiloxane or mixture of polysiloxanes, wherein the polysiloxane(s) include: 40-80 combined wt % (based on total weight of polysiloxane(s)) of M and Q units, and 2.8-20 wt % (based on total weight of polysiloxane(s)) of diphenylsiloxane units according to the formula —Si(Ph)₂—O—.

In another aspect, the present disclosure provides films having a thickness of greater than 5 microns and less than 60 microns, in some embodiments less than 20 microns, comprising a damping adhesive obtained by crosslinking polysiloxane(s), wherein the crosslinking is accomplished by blending into in the polysiloxane(s) a peroxide crosslinking agent in an amount equal to between 1.0% and 3.5% of the weight of the polysiloxane(s) and crosslinking the polysiloxane(s) by activating the peroxide crosslinking agent, wherein polysiloxane(s) means a polysiloxane or mixture of polysiloxanes, wherein the polysiloxane(s) include: 40-80 combined wt % (based on total weight of polysiloxane(s)) of M and Q units, and 5-20 wt % (based on total weight of polysiloxane(s)) of diphenylsiloxane units according to the formula —Si(Ph)₂—O—. In some embodiments, the peroxide crosslinking agent is benzoyl peroxide.

In some embodiments of the films of the present disclosure, the polysiloxane(s) also include 5-35 wt % (based on total weight of polysiloxane(s)) of dimethylsiloxane units according to the formula —Si(Me)₂—O—. In some embodiments of the films of the present disclosure, the polysiloxane(s) include 64-76 combined wt % (based on total weight of polysiloxane(s)) of M and Q units. In some embodiments of the films of the present disclosure, the damping adhesive comprises no segments derived from acrylate monomers. In some embodiments of the films of the present disclosure, the damping adhesive exhibits shear adhesion to stainless steel at 1000 gram test weight and 70° C. of greater than 6000 minutes. Additional embodiments of the films of the present disclosure are described below under “Selected Embodiments.”

In some embodiments of the films of the present disclosure, the damping adhesive exhibits a tan delta at −40° C. of at least 0.30, at least 0.40, at least 0.45, at least 0.60, or at least 0.90.

In another aspect, the present disclosure provides microspeaker diaphragm materials comprising two or more stiff layers and at least one damping layer, where the damping layer is a film according to the present disclosure.

In another aspect, the present disclosure provides subassemblies for the manufacture of microspeaker diaphragm material comprising a stiff layer and a damping layer, wherein the damping layer is the film according to the present disclosure.

In another aspect, the present disclosure provides transfer tapes comprising the films according to the present disclosure.

Additional embodiments of the microspeaker diaphragm materials, subassemblies and transfer tapes of the present disclosure are described below under “Selected Embodiments.”

The preceding summary of the present disclosure is not intended to describe each embodiment of the present invention. The details of one or more embodiments of the invention are also set forth in the description below. Other features, objects, and advantages of the invention will be apparent from the description and from the claims.

In this application:

“directly bound” refers to two materials that are in direct contact with each other and bound together with no third material intermediating between them.

All scientific and technical terms used herein have meanings commonly used in the art unless otherwise specified.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

### BRIEF DESCRIPTION OF THE DRAWING

FIG. 1 is a schematic cross-section of a three-layer microspeaker diaphragm material according to one embodiment of the present disclosure.

FIG. 2 is a schematic cross-section of a five-layer microspeaker diaphragm material according to one embodiment of the present disclosure.

FIG. 3 is a schematic cross-section of a subassembly according to one embodiment of the present disclosure.

FIG. 4 is a schematic cross-section of a transfer tape according to one embodiment of the present disclosure.

FIG. 5 is a graph presenting dynamic mechanical analysis data measured for one embodiment of the present disclosure, which is Example 4 herein.

### DETAILED DESCRIPTION

The present disclosure provides a microspeaker diaphragm material comprising two or more stiff layers and at least one damping layer as provided herein, each face of each damping layer being directly bound to a stiff layer. Also provided are articles that in some embodiments may be used as subcomponents to microspeaker diaphragm materials, such as a subassembly comprising a stiff layer directly bound to a face of a damping layer, or a transfer tape comprising a damping layer borne on a liner layer.

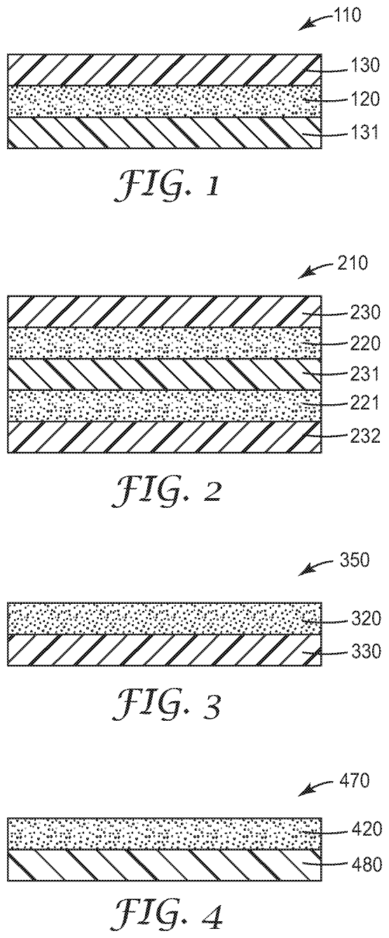

With reference to FIG. 1, a three-layer microspeaker diaphragm material 110 according to some embodiments of the present disclosure includes damping layer 120 and stiff layers 130, 131 bound directly to damping layer 120. With reference to FIG. 2, a five-layer microspeaker diaphragm material 210 according to some embodiments of the present disclosure includes damping layers 220, 221 alternating with and stiff layers 230, 231, 232. Damping layers 220, 221 are bound directly to those stiff layers 230, 231, 232 to which they are adjacent. Additional embodiments may comprise seven, nine, or more layers, comprising alternating stiff and damping layers.

With reference to FIG. 3, a two-layer subassembly 350 according to some embodiments of the present disclosure includes damping layer 320 bound directly to stiff layer 330. With reference to FIG. 4, a transfer tape 470 according to some embodiments of the present disclosure includes damping layer 420 borne on liner layer 480. Optionally, the exposed face of damping layer 420 may bear a second liner layer, not shown.

In some embodiments, the microspeaker diaphragm damping layers are adhesives. In some embodiments, the microspeaker diaphragm damping layers can operate at temperatures up to 200° C., and in some embodiments up to 250° C., without loss of damping characteristics. In some embodiments, the damping layer comprises a damping adhesive which comprises a polysiloxane or mixture of polysiloxanes that exhibits a tan delta of at least 0.42 for every temperature between 20° C. and 200° C., and in some embodiments for every temperature between 20° C. and 250° C. In some embodiments, the damping adhesive exhibits a tan delta at 200° C. that is no more than 0.08 greater than the minimum tan delta measured in the range of 20° C. to 200° C. In some embodiments, the damping adhesive exhibits a tan delta at 250° C. that is no more than 0.20 greater than the minimum tan delta measured in the range of 20° C. to 250° C. In some embodiments of the films of the present disclosure, the damping adhesive exhibits a tan delta at −40° C. of at least 0.30, at least 0.40, at least 0.45, at least 0.60, or at least 0.90. Additional embodiments may be limited to the characteristic ranges recited in the Selected Embodiments below.

In some embodiments, the damping adhesive is crosslinked. In some such embodiments, the damping adhesive is crosslinked by exposure to e-beam radiation. In some such embodiments, the damping adhesive is crosslinked by the use of peroxides. Typically the damping adhesive is coated into a thin film prior to crosslinking, in some embodiments having a thickness of greater than 5 microns and less than 60 microns, in some embodiments less than 20 microns. Additional embodiments may be limited to the thickness ranges recited in the Selected Embodiments below.

### Polysiloxanes

In some embodiments, the damping layer comprises a damping adhesive which comprises a polysiloxane or mixture of polysiloxanes. In some such embodiments, the damping layer comprises one or more MQ resins and one or more linear or branched polysiloxanes.

Suitable MQ resins are composed of the following structural units M (i.e., monovalent R′₃SiO_{1/2} units) and Q (i.e., quaternary SiO_{4/2} units). It is contemplated that MQ resins useful in the present disclosure may optionally include minor amounts of D units (i.e., divalent R′₂SiO_{2/2} units), T units (i.e., trivalent R′SiO_{3/2} units), or “T^{OH}” units (i.e., Q units bonded to hydroxyl radicals resulting in HOSiO_{3/2} units). In some embodiments the MQ resins contain only M and Q units. Typically MQ resins have a number average molecular weight in the range of 100 to 50,000-gm/mole, e.g., 500 to 15,000 gm/mole and generally R′ groups are methyl groups. MQ resins are copolymeric resins where each M unit is bonded to a Q unit, and each Q unit is bonded to at least one other Q unit. Some of the Q units are bonded to only other Q units. Suitable silicate tackifying resins are commercially available from sources such as Dow Corning (e.g., DC 2-7066), Momentive Performance Materials (e.g., SR545 and SR1000).

Any suitable linear or branched polysiloxanes may be used in the practice of the present invention. Some embodiments employ linear polysiloxanes described by the following formula illustrating a siloxane backbone with aliphatic and/or aromatic substituents:

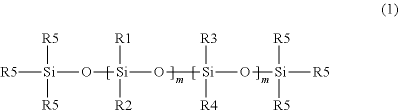

wherein R1, R2, R3, and R4 are independently selected from the group consisting of an alkyl group and an aryl group, each R5 is an alkyl group and n and m are integers, and at least one of m or n is not zero. In some embodiments, R5 is a methyl group, i.e., the nonfunctionalized silicone material is terminated by trimethylsiloxy groups. In some embodiments, R1 and R2 are alkyl groups and n is zero, i.e., the material is a poly(dialkylsiloxane). In some embodiments, the alkyl group is a methyl group, i.e., poly(dimethylsiloxane) (“PDMS”). In some embodiments, R1 is an alkyl group, R2 is an aryl group, and n is zero, i.e., the material is a poly(alkylarylsiloxane). In some embodiments, R1 is methyl group and R2 is a phenyl group, i.e., the material is poly(methylphenylsiloxane). In some embodiments, R1 and R2 are alkyl groups and R3 and R4 are aryl groups, i.e., the material is a poly(dialkyldiarylsiloxane). In some embodiments, R1 and R2 are methyl groups, and R3 and R4 are phenyl groups, i.e., the material is poly(dimethyldiphenylsiloxane).

In addition to functional R-groups, the R-groups may be nonfunctional groups, e.g., alkyl or aryl groups, including halogenated (e.g., fluorinated) alky and aryl groups. In some embodiments, the functionalized silicone materials may be branched. For example, one or more of the R groups may be a linear or branched siloxane with functional and/or non-functional substituents.

The polysiloxanes may be combined by any of a wide variety of known means. In some embodiments, the various components may be pre-blended using common equipment such as mixers, blenders, mills, extruders, and the like. Blending may be carried out with or without the presence of solvent. In some embodiments, combination of MQ resin with other polysiloxanes may include covalent bonding to the MQ resin.

In some embodiments, the polysiloxane or polysiloxanes include 40-80 combined wt % (based on total weight of polysiloxane(s)) of M and Q units. In some embodiments, the polysiloxane or polysiloxanes include 60-80 combined wt % (based on total weight of polysiloxane(s)) of M and Q units. In some embodiments the polysiloxane or polysiloxanes include 2.8-20 wt % (based on total weight of polysiloxane(s)) of diphenylsiloxane units according to the formula —Si(Ph)₂—O—. In some embodiments the polysiloxane or polysiloxanes include 5-15 wt % (based on total weight of polysiloxane(s)) of diphenylsiloxane units according to the formula —Si(Ph)₂—O—. Additional embodiments may be limited to the compositions recited in the Selected Embodiments below.

### E-Beam Crosslinking

In some embodiments, the polysiloxane or mixture of polysiloxanes which form the damping layer are crosslinked by exposure to e-beam radiation.

Typically the polysiloxane or mixture of polysiloxanes is coated into a thin film prior to crosslinking, in some embodiments having a thickness of greater than 5 microns and less than 60 microns, in some embodiments less than 20 microns. Any suitable method of coating may be used, including solvent coating and hot melt coating methods.

E-beam crosslinking can be carried out by any suitable method. Commercially available electron beam generating equipment are available, including those available from Energy Sciences, Inc. (Wilmington, Mass.). Generally, a support film or liner runs through an inert chamber, typically a nitrogen atmosphere. In some embodiments, a sample of uncured material with a liner on both sides is treated. In some embodiments, a sample of the uncured material may be applied to one liner, with no liner on the opposite surface (“open face”). The material may be exposed to E-beam irradiation from one side through the release liner. In some embodiments, no catalysts or initiators are employed, and thus such compositions are “substantially free” of any catalysts or initiators. As used herein, a composition is “substantially free of catalysts and initiators” if the composition does not include an “effective amount” of a catalyst or initiator. As is well understood, an “effective amount” of a catalyst or initiator depends on a variety of factors including the type of catalyst or initiator, the composition of the curable material, and the curing method (e.g., thermal cure, UV-cure, and the like). In some embodiments, a particular catalyst or initiator is not present at an “effective amount” if the amount of catalyst or initiator does not reduce the cure time of the composition by at least 10% relative to the cure time for same composition at the same curing conditions, absent that catalyst or initiator.

In some embodiments, the e-beam exposure is limited to between 1.5 and 5.5 Mrad of e-beam radiation at a voltage of greater than 100 kV or more typically greater than 150 kV. Additional embodiments may be limited to the film thicknesses, compositions, conditions and/or exposures recited in the Selected Embodiments below.

### Peroxide Crosslinking

In some embodiments, the polysiloxane or mixture of polysiloxanes which form the damping layer are crosslinked by use of peroxide crosslinkers.

Typically the polysiloxane or mixture of polysiloxanes is coated into a thin film prior to crosslinking, in some embodiments having a thickness of greater than 5 microns and less than 60 microns, in some embodiments less than 20 microns. Any suitable method of coating may be used, including solvent coating and hot melt coating methods.

Peroxide crosslinking can be carried out by any suitable method. Typically, crosslinking is accomplished by blending into in the polysiloxane(s) a peroxide crosslinking agent in an amount equal to between 1.0% and 3.5% of the weight of the polysiloxane(s) and, after coating, activating the peroxide crosslinking agent, typically with heat. Additional embodiments may be limited to the film thicknesses, compositions, and/or conditions recited in the Selected Embodiments below.

### Stiff Layers

Any suitable stiff layers may be used in embodiments of the present disclosure. In some embodiments, each stiff layer has a thickness independently chosen from thicknesses greater than 1 micron and less than 10 microns. Additional embodiments may be limited to the thickness ranges recited in the Selected Embodiments below.

In some embodiments, stiff layers comprise high temperature engineering thermoplastics. In some embodiments, stiff layers comprise materials selected from: polybenzimidazoles, polyamide-imides, polyimides, liquid crystal polymers, polyether sulfones, polyphenyl sulfones, polyetherimides, polyether ether ketones, and polysulfones. In some embodiments, stiff layers comprise polyether ether ketone (PEEK).

### Selected Embodiments

The following embodiments, designated by letter and number, are intended to further illustrate the present disclosure but should not be construed to unduly limit this disclosure.

DAFa1. A film having a thickness of at least 4 microns and less than 60 microns comprising a damping adhesive which comprises a polysiloxane or mixture of polysiloxanes, wherein the damping adhesive exhibits a tan delta of at least 0.42 for every temperature between 20° C. and 250° C., and wherein the damping adhesive exhibits a tan delta at 250° C. that is no more than 0.20 greater than the minimum tan delta measured in the range of 20° C. to 250° C.
DAFa2. The film according to embodiment DAFa1 wherein the damping adhesive exhibits a tan delta at 250° C. that is no more than 0.17 greater than the minimum tan delta measured in the range of 20° C. to 250° C.
DAFa3. The film according to embodiment DAFa1 wherein the damping adhesive exhibits a tan delta at 250° C. that is no more than 0.13 greater than the minimum tan delta measured in the range of 20° C. to 250° C.
DAFa4. The film according to embodiment DAFa1 wherein the damping adhesive exhibits a tan delta at 250° C. that is no more than 0.10 greater than the minimum tan delta measured in the range of 20° C. to 250° C.

DAFa5. The film according to embodiment DAFa1 wherein the damping adhesive exhibits a tan delta at 250° C. that is no more than 0.08 greater than the minimum tan delta measured in the range of 20° C. to 250° C.

DAFa6. The film according to any of embodiments DAFa1 to DAFa5 wherein the damping adhesive exhibits a tan delta at 200° C. that is no more than 0.08 greater than the minimum tan delta measured in the range of 20° C. to 200° C.
DAFa7. The film according to any of embodiments DAFa1 to DAFa5 wherein the damping adhesive exhibits a tan delta at 200° C. that is no more than 0.07 greater than the minimum tan delta measured in the range of 20° C. to 200° C.
DAFa8. The film according to any of embodiments DAFa1 to DAFa5 wherein the damping adhesive exhibits a tan delta at 200° C. that is no more than 0.06 greater than the minimum tan delta measured in the range of 20° C. to 200° C.
DAFa9. The film according to any of embodiments DAFa1 to DAFa5 wherein the damping adhesive exhibits a tan delta at 200° C. that is no more than 0.05 greater than the minimum tan delta measured in the range of 20° C. to 200° C.
DAFa10. The film according to any of embodiments DAFa1 to DAFa5 wherein the damping adhesive exhibits a tan delta at 200° C. that is no more than 0.04 greater than the minimum tan delta measured in the range of 20° C. to 200° C.
DAFa11. The film according to any of embodiments DAFa1 to DAFa5 wherein the damping adhesive exhibits a tan delta at 200° C. that is no more than 0.03 greater than the minimum tan delta measured in the range of 20° C. to 200° C.
DAFa12. The film according to any of embodiments DAFa1 to DAFa5 wherein the damping adhesive exhibits a tan delta at 200° C. that is no more than 0.02 greater than the minimum tan delta measured in the range of 20° C. to 200° C.
DAFa13. The film according to any of embodiments DAFa1 to DAFa5 wherein the damping adhesive exhibits a tan delta at 200° C. that is no more than 0.01 greater than the minimum tan delta measured in the range of 20° C. to 200° C.
DAFa14. The film according to any of embodiments DAFa1 to DAFa13, wherein the damping adhesive exhibits a tan delta of at least 0.45 for every temperature between 20° C. and 250° C.
DAFa15. The film according to any of embodiments DAFa1 to DAFa13, wherein the damping adhesive exhibits a tan delta of at least 0.48 for every temperature between 20° C. and 250° C.
DAFa16. The film according to any of embodiments DAFa1 to DAFa13, wherein the damping adhesive exhibits a tan delta of at least 0.51 for every temperature between 20° C. and 250° C.
DAFa17. The film according to any of embodiments DAFa1 to DAFa13, wherein the damping adhesive exhibits a tan delta of at least 0.53 for every temperature between 20° C. and 250° C.
DAFa18. The film according to any of embodiments DAFa1-DAFa17 wherein tan delta is measured by dynamic mechanical analysis.
DAFa19. The film according to any of embodiments DAFa1-DAFa18 having a thickness of greater than 7 microns.
DAFa20. The film according to any of embodiments DAFa1-DAFa19 having a thickness of less than 45 microns.
DAFa21. The film according to any of embodiments DAFa1-DAFa19 having a thickness of less than 20 microns.
DAFa22. The film according to any of embodiments DAFa1-DAFa19 having a thickness of less than 17 microns.
DAFa23. The film according to any of embodiments DAFa1-DAFa19 having a thickness of less than 15 microns.
DAFa24. The film according to any of embodiments DAFa1-DAFa19 having a thickness of less than 14 microns.
DAFa25. The film according to any of embodiments DAFa1-DAFa19 having a thickness of less than 13 microns.
DAFa26. The film according to any of embodiments DAFa1-DAFa25 wherein the damping adhesive comprises no segments derived from acrylate monomers.
DAFa27. The film according to any of embodiments DAFa1-DAFa25 wherein the damping adhesive exhibits shear adhesion to stainless steel at 1000 gram test weight and 70° C. of greater than 2000 minutes.
DAFa28. The film according to any of embodiments DAFa1-DAFa25 wherein the damping adhesive exhibits shear adhesion to stainless steel at 1000 gram test weight and 70° C. of greater than 4000 minutes.
DAFa29. The film according to any of embodiments DAFa1-DAFa25 wherein the damping adhesive exhibits shear adhesion to stainless steel at 1000 gram test weight and 70° C. of greater than 6000 minutes.
DAFa30. The film according to any of embodiments DAFa1-DAFa29 having modulus (G′) at 25° C. of less than 100,000 Pa.
DAFa31. The film according to any of embodiments DAFa1 to DAFa30, wherein the damping adhesive exhibits a tan delta of at least 0.30 at −40° C.
DAFa32. The film according to any of embodiments DAFa1 to DAFa30, wherein the damping adhesive exhibits a tan delta of at least 0.40 at −40° C.
DAFa33. The film according to any of embodiments DAFa1 to DAFa30, wherein the damping adhesive exhibits a tan delta of at least 0.45 at −40° C.
DAFa34. The film according to any of embodiments DAFa1 to DAFa30, wherein the damping adhesive exhibits a tan delta of at least 0.60 at −40° C.
DAFa35. The film according to any of embodiments DAFa1 to DAFa30, wherein the damping adhesive exhibits a tan delta of at least 0.90 at −40° C.
DAFb1. A film having a thickness of at least 4 microns and less than 60 microns comprising a damping adhesive which comprises a polysiloxane or mixture of polysiloxanes, wherein the damping adhesive exhibits a tan delta of at least 0.42 for every temperature between 20° C. and 200° C., and wherein the damping adhesive exhibits a tan delta at 200° C. that is no more than 0.08 greater than the minimum tan delta measured in the range of 20° C. to 200° C.
DAFb2. The film according to embodiment DAFb1 wherein the damping adhesive exhibits a tan delta at 200° C. that is no more than 0.07 greater than the minimum tan delta measured in the range of 20° C. to 200° C.
DAFb3. The film according to embodiment DAFb1 wherein the damping adhesive exhibits a tan delta at 200° C. that is no more than 0.06 greater than the minimum tan delta measured in the range of 20° C. to 200° C.
DAFb4. The film according to embodiment DAFb1 wherein the damping adhesive exhibits a tan delta at 200° C. that is no more than 0.05 greater than the minimum tan delta measured in the range of 20° C. to 200° C.
DAFb5. The film according to embodiment DAFb1 wherein the damping adhesive exhibits a tan delta at 200° C. that is no more than 0.04 greater than the minimum tan delta measured in the range of 20° C. to 200° C.
DAFb6. The film according to embodiment DAFb1 wherein the damping adhesive exhibits a tan delta at 200° C. that is no more than 0.03 greater than the minimum tan delta measured in the range of 20° C. to 200° C.
DAFb7. The film according to embodiment DAFb1 wherein the damping adhesive exhibits a tan delta at 200° C. that is no more than 0.02 greater than the minimum tan delta measured in the range of 20° C. to 200° C.
DAFb8. The film according to embodiment DAFb1 wherein the damping adhesive exhibits a tan delta at 200° C. that is no more than 0.01 greater than the minimum tan delta measured in the range of 20° C. to 200° C.
DAFb10. The film according to any of embodiments DAFb1 to DAFb8, wherein the damping adhesive exhibits a tan delta of at least 0.45 for every temperature between 20° C. and 200° C.
DAFb11. The film according to any of embodiments DAFb1 to DAFb8, wherein the damping adhesive exhibits a tan delta of at least 0.48 for every temperature between 20° C. and 200° C.
DAFb12. The film according to any of embodiments DAFb1 to DAFb8, wherein the damping adhesive exhibits a tan delta of at least 0.51 for every temperature between 20° C. and 200° C.
DAFb13. The film according to any of embodiments DAFb1 to DAFb8, wherein the damping adhesive exhibits a tan delta of at least 0.53 for every temperature between 20° C. and 200° C.
DAFb14. The film according to any of embodiments DAFb1 to DAFb13 wherein tan delta is measured by dynamic mechanical analysis.
DAFb15. The film according to any of embodiments DAFb1 to DAFb14 having a thickness of greater than 7 microns.
DAFb16. The film according to any of embodiments DAFb1 to DAFb15 having a thickness of less than 45 microns.
DAFb17. The film according to any of embodiments DAFb1 to DAFb15 having a thickness of less than 20 microns.
DAFb18. The film according to any of embodiments DAFb1 to DAFb15 having a thickness of less than 17 microns.
DAFb19. The film according to any of embodiments DAFb1 to DAFb15 having a thickness of less than 15 microns.
DAFb20. The film according to any of embodiments DAFb1 to DAFb15 having a thickness of less than 14 microns.
DAFb21. The film according to any of embodiments DAFb1 to DAFb15 having a thickness of less than 13 microns.
DAFb22. The film according to any of embodiments DAFb1 to DAFb21 wherein the damping adhesive comprises no segments derived from acrylate monomers.
DAFb23. The film according to any of embodiments DAFb1 to DAFb22 wherein the damping adhesive exhibits shear adhesion to stainless steel at 1000 gram test weight and 70° C. of greater than 2000 minutes.
DAFb24. The film according to any of embodiments DAFb1 to DAFb22 wherein the damping adhesive exhibits shear adhesion to stainless steel at 1000 gram test weight and 70° C. of greater than 4000 minutes.
DAFb25. The film according to any of embodiments DAFb1 to DAFb22 wherein the damping adhesive exhibits shear adhesion to stainless steel at 1000 gram test weight and 70° C. of greater than 6000 minutes.
DAFb26. The film according to any of embodiments DAFb1-DAFb25 having modulus (G′) at 25° C. of less than 100,000 Pa.
DAFb27. The film according to any of embodiments DAFb1 to DAFb26, wherein the damping adhesive exhibits a tan delta of at least 0.30 at −40° C.
DAFb28. The film according to any of embodiments DAFb1 to DAFb26, wherein the damping adhesive exhibits a tan delta of at least 0.40 at −40° C.
DAFb29. The film according to any of embodiments DAFb1 to DAFb26, wherein the damping adhesive exhibits a tan delta of at least 0.45 at −40° C.
DAFb30. The film according to any of embodiments DAFb1 to DAFb26, wherein the damping adhesive exhibits a tan delta of at least 0.60 at −40° C.
DAFb31. The film according to any of embodiments DAFb1 to DAFb26, wherein the damping adhesive exhibits a tan delta of at least 0.90 at −40° C.
DAFe1. A film having a thickness of at least 4 microns and less than 60 microns comprising a damping adhesive, obtained by crosslinking polysiloxane(s) by exposing the polysiloxane(s) in the form of a polysiloxane film having a thickness of greater than 5 microns and less than 20 microns to between 1.5 and 5.5 Mrad of e-beam radiation at a voltage of greater than 150 kV, wherein polysiloxane(s) means a polysiloxane or mixture of polysiloxanes, wherein the polysiloxane(s) include:
40-80 combined wt % (based on total weight of polysiloxane(s)) of M and Q units, and
2.8-20 wt % (based on total weight of polysiloxane(s)) of diphenylsiloxane units according to the formula —Si(Ph)₂—O—.
   DAFe2. The film according to embodiment DAFe1 having a thickness of greater than 7 microns.
   DAFe3. The film according to embodiment DAFe1 or DAFe2 having a thickness of less than 45 microns.
   DAFe4. The film according to embodiment DAFe1 or DAFe2 having a thickness of less than 20 microns.
   DAFe5. The film according to embodiment DAFe1 or DAFe2 having a thickness of less than 17 microns.
   DAFe6. The film according to embodiment DAFe1 or DAFe2 having a thickness of less than 15 microns.
   DAFe7. The film according to embodiment DAFe1 or DAFe2 having a thickness of less than 14 microns.
   DAFe8. The film according to embodiment DAFe1 or DAFe2 having a thickness of less than 13 microns.
   DAFe9. The film according to any of embodiments DAFe1 to DAFe8 wherein the polysiloxane(s) include:
5-35 wt % (based on total weight of polysiloxane(s)) of dimethylsiloxane units according to the formula —Si(Me)₂—O—.
   DAFe10. The film according to any of embodiments DAFe1 to DAFe9 wherein the polysiloxane(s) comprises a MQ polysiloxane and a linear polysiloxane, where the linear polysiloxane comprises diphenylsiloxane and dimethylsiloxane units.
   DAFe11. The film according to any of embodiments DAFe1 to DAFe9 wherein the polysiloxane(s) comprises a MQ polysiloxane, a first linear polysiloxane, and a second linear polysiloxane different in composition from the first linear polysiloxane, wherein the first linear polysiloxane comprises diphenylsiloxane and dimethylsiloxane units.
   DAFe12. The film according to any of embodiments DAFe1 to DAFe9 wherein the polysiloxane(s) comprises a first MQ polysiloxane, a second MQ polysiloxane different in composition from the first MQ polysiloxane, a first linear polysiloxane, and a second linear polysiloxane different in composition from the first linear polysiloxane, wherein the first linear polysiloxane comprises diphenylsiloxane and dimethylsiloxane units.
   DAFe13. The film according to any of embodiments DAFe1 to DAFe12 wherein the polysiloxane(s) include:
60-80 combined wt % (based on total weight of polysiloxane(s)) of M and Q units.
   DAFe14. The film according to any of embodiments DAFe1 to DAFe12 wherein the polysiloxane(s) include:
62-78 combined wt % (based on total weight of polysiloxane(s)) of M and Q units.
   DAFe15. The film according to any of embodiments DAFe1 to DAFe12 wherein the polysiloxane(s) include:
64-76 combined wt % (based on total weight of polysiloxane(s)) of M and Q units.
   DAFe16. The film according to any of embodiments DAFe1 to DAFe12 wherein the polysiloxane(s) include:
66-74 combined wt % (based on total weight of polysiloxane(s)) of M and Q units.
   DAFe17. The film according to any of embodiments DAFe1 to DAFe12 wherein the polysiloxane(s) include:
68-72 combined wt % (based on total weight of polysiloxane(s)) of M and Q units.
   DAFe18. The film according to any of embodiments DAFe1 to DAFe17 wherein the polysiloxane(s) include:
at least 6 wt % (based on total weight of polysiloxane(s)) of diphenylsiloxane units according to the formula —Si(Ph)₂—O—.
   DAFe19. The film according to any of embodiments DAFe1 to DAFe17 wherein the polysiloxane(s) include:
at least 7 wt % (based on total weight of polysiloxane(s)) of diphenylsiloxane units according to the formula —Si(Ph)₂—O—.
   DAFe20. The film according to any of embodiments DAFe1 to DAFe19 wherein the polysiloxane(s) include:
not more than 15 wt % (based on total weight of polysiloxane(s)) of diphenylsiloxane units according to the formula —Si(Ph)₂—O—.
   DAFe21. The film according to any of embodiments DAFe1 to DAFe19 wherein the polysiloxane(s) include:
not more than 12 wt % (based on total weight of polysiloxane(s)) of diphenylsiloxane units according to the formula —Si(Ph)₂—O—.
   DAFe22. The film according to any of embodiments DAFe1 to DAFe19 wherein the polysiloxane(s) include:
not more than 10 wt % (based on total weight of polysiloxane(s)) of diphenylsiloxane units according to the formula —Si(Ph)₂—O—.
   DAFe23. The film according to any of embodiments DAFe1 to DAFe19 wherein the polysiloxane(s) include:
not more than 9.5 wt % (based on total weight of polysiloxane(s)) of diphenylsiloxane units according to the formula —Si(Ph)₂—O—.
   DAFe24. The film according to any of embodiments DAFe1 to DAFe19 wherein the polysiloxane(s) include:
not more than 9 wt % (based on total weight of polysiloxane(s)) of diphenylsiloxane units according to the formula —Si(Ph)₂—O—.
   DAFe25. The film according to any of embodiments DAFe1 to DAFe24 wherein the crosslinking is accomplished by exposing the polysiloxane(s) to e-beam radiation through a polymeric liner covering an upper surface of the polysiloxane(s).
   DAFe26. The film according to embodiment DAFe25 wherein the polymeric liner has a thickness of less than 100 microns.
   DAFe27. The film according to embodiment DAFe25 wherein the polymeric liner has a thickness of less than 80 microns.
   DAFe28. The film according to embodiment DAFe25 wherein the polymeric liner has a thickness of less than 55 microns.
   DAFe29. The film according to any of embodiments DAFe25 to DAFe28 wherein the polymeric liner comprises a polyester.
   DAFe30. The film according to any of embodiments DAFe1 to DAFe24 wherein the crosslinking is accomplished by exposing the polysiloxane(s) directly to e-beam radiation, unmediated by any solid material.
   DAFe31. The film according to any of embodiments DAFe1 to DAFe30 wherein the polysiloxane(s) are exposed to between 2.8 and 5.5 Mrad of e-beam radiation.
   DAFe32. The film according to any of embodiments DAFe1 to DAFe30 wherein the polysiloxane(s) are exposed to between 1.8 and 4.2 Mrad of e-beam radiation.
   DAFe33. The film according to any of embodiments DAFe1 to DAFe30 wherein the polysiloxane(s) are exposed to between 2.8 and 4.2 Mrad of e-beam radiation.
   DAFe34. The film according to any of embodiments DAFe1 to DAFe30 wherein the polysiloxane(s) are exposed to between 1.8 and 3.7 Mrad of e-beam radiation.
   DAFe35. The film according to any of embodiments DAFe1 to DAFe30 wherein the polysiloxane(s) are exposed to between 2.8 and 3.7 Mrad of e-beam radiation.
   DAFe36. The film according to any of embodiments DAFe1 to DAF30 wherein the polysiloxane(s) are exposed to between 1.8 and 3.3 Mrad of e-beam radiation.
   DAFe37. The film according to any of embodiments DAFe1 to DAFe30 wherein the polysiloxane(s) are exposed to between 2.8 and 3.3 Mrad of e-beam radiation.
   DAFe38. The film according to any of embodiments DAFe1 to DAFe30 wherein the polysiloxane(s) are exposed to between 2.8 and 3.3 Mrad of e-beam radiation.
   DAFe39. The film according to any of embodiments DAFe1 to DAFe38 wherein the polysiloxane(s) are exposed to e-beam radiation at a voltage of greater than 180 kV.
   DAFe40. The film according to any of embodiments DAFe1 to DAFe38 wherein the polysiloxane(s) are exposed to e-beam radiation at a voltage of greater than 200 kV.
   DAFe41. The film according to any of embodiments DAFe1 to DAFe38 wherein the polysiloxane(s) are exposed to e-beam radiation at a voltage of greater than 220 kV.
   DAFe42. The film according to any of embodiments DAFe1 to DAFe41 wherein the polysiloxane(s) are exposed to e-beam radiation at a voltage of no more than 280 kV.
   DAFe43. The film according to any of embodiments DAFE1 to DAFe42 wherein the crosslinking is accomplished in the absence of any crosslinking agent in the polysiloxane(s).
   DAFe44. The film according to any of embodiments DAFe1 to DAFe43 wherein the polysiloxane film has a thickness of greater than 7 microns.
   DAFe45. The film according to any of embodiments DAFe1 to DAFe44 wherein the polysiloxane film has a thickness of less than 18 microns.
   DAFe46. The film according to any of embodiments DAFe1 to DAFe44 wherein the polysiloxane film has a thickness of less than 17 microns.
   DAFe47. The film according to any of embodiments DAFe1 to DAFe44 wherein the polysiloxane film has a thickness of less than 15 microns.
   DAFe48. The film according to any of embodiments DAFe1 to DAFe44 wherein the polysiloxane film has a thickness of less than 14 microns.
   DAFe49. The film according to any of embodiments DAFe1 to DAFe44 wherein the polysiloxane film has a thickness of less than 13 microns.
   DAFe50. The film according to any of embodiments DAFe1 to DAFe49 wherein the damping adhesive comprises no segments derived from acrylate monomers.
   DAFe51. The film according to any of embodiments DAFe1 to DAFe50 wherein the damping adhesive exhibits a tan delta of at least 0.42 for every temperature between 20° C. and 200° C., and wherein the damping adhesive exhibits a tan delta at 200° C. that is no more than 0.08 greater than the minimum tan delta measured in the range of 20° C. to 200° C.
   DAFe52. The film according to any of embodiments DAFe1 to DAFe50 wherein the damping adhesive exhibits a tan delta of at least 0.42 for every temperature between 20° C. and 200° C., and wherein the damping adhesive exhibits a tan delta at 200° C. that is no more than 0.07 greater than the minimum tan delta measured in the range of 20° C. to 200° C.
   DAFe53. The film according to any of embodiments DAFe1 to DAFe50 wherein the damping adhesive exhibits a tan delta of at least 0.42 for every temperature between 20° C. and 200° C., and wherein the damping adhesive exhibits a tan delta at 200° C. that is no more than 0.06 greater than the minimum tan delta measured in the range of 20° C. to 200° C.
   DAFe54. The film according to any of embodiments DAFe1 to DAFe50 wherein the damping adhesive exhibits a tan delta of at least 0.42 for every temperature between 20° C. and 200° C., and wherein the damping adhesive exhibits a tan delta at 200° C. that is no more than 0.05 greater than the minimum tan delta measured in the range of 20° C. to 200° C.
   DAFe55. The film according to any of embodiments DAFe1 to DAFe50 wherein the damping adhesive exhibits a tan delta of at least 0.42 for every temperature between 20° C. and 200° C., and wherein the damping adhesive exhibits a tan delta at 200° C. that is no more than 0.04 greater than the minimum tan delta measured in the range of 20° C. to 200° C.
   DAFe56. The film according to any of embodiments DAFe1 to DAFe50 wherein the damping adhesive exhibits a tan delta of at least 0.42 for every temperature between 20° C. and 200° C., and wherein the damping adhesive exhibits a tan delta at 200° C. that is no more than 0.03 greater than the minimum tan delta measured in the range of 20° C. to 200° C.
   DAFe57. The film according to any of embodiments DAFe1 to DAFe50 wherein the damping adhesive exhibits a tan delta of at least 0.42 for every temperature between 20° C. and 200° C., and wherein the damping adhesive exhibits a tan delta at 200° C. that is no more than 0.02 greater than the minimum tan delta measured in the range of 20° C. to 200° C.
   DAFe58. The film according to any of embodiments DAFe1 to DAFe50 wherein the damping adhesive exhibits a tan delta of at least 0.42 for every temperature between 20° C. and 200° C., and wherein the damping adhesive exhibits a tan delta at 200° C. that is no more than 0.01 greater than the minimum tan delta measured in the range of 20° C. to 200° C.
   DAFe59. The film according to any of embodiments DAFe1 to DAFe58 wherein the damping adhesive exhibits a tan delta of at least 0.42 for every temperature between 20° C. and 250° C., and wherein the damping adhesive exhibits a tan delta at 250° C. that is no more than 0.20 greater than the minimum tan delta measured in the range of 20° C. to 250° C.
   DAFe60. The film according to any of embodiments DAFe1 to DAFe58 wherein the damping adhesive exhibits a tan delta of at least 0.42 for every temperature between 20° C. and 250° C., and wherein the damping adhesive exhibits a tan delta at 250° C. that is no more than 0.17 greater than the minimum tan delta measured in the range of 20° C. to 250° C.
   DAFe61. The film according to any of embodiments DAFe1 to DAFe58 wherein the damping adhesive exhibits a tan delta of at least 0.42 for every temperature between 20° C. and 250° C., and wherein the damping adhesive exhibits a tan delta at 250° C. that is no more than 0.13 greater than the minimum tan delta measured in the range of 20° C. to 250° C.
   DAFe62. The film according to any of embodiments DAFe1 to DAFe58 wherein the damping adhesive exhibits a tan delta of at least 0.42 for every temperature between 20° C. and 250° C., and wherein the damping adhesive exhibits a tan delta at 250° C. that is no more than 0.10 greater than the minimum tan delta measured in the range of 20° C. to 250° C.
   DAFe63. The film according to any of embodiments DAFe1 to DAFe58 wherein the damping adhesive exhibits a tan delta of at least 0.42 for every temperature between 20° C. and 250° C., and wherein the damping adhesive exhibits a tan delta at 250° C. that is no more than 0.08 greater than the minimum tan delta measured in the range of 20° C. to 250° C.
   DAFe64. The film according to any of embodiments DAFe1 to DAFe63, wherein the damping adhesive exhibits a tan delta of at least 0.45 for every temperature between 20° C. and 250° C.
   DAFe65. The film according to any of embodiments DAFe1 to DAFe63, wherein the damping adhesive exhibits a tan delta of at least 0.48 for every temperature between 20° C. and 250° C.
   DAFe66. The film according to any of embodiments DAFe1 to DAFe63, wherein the damping adhesive exhibits a tan delta of at least 0.51 for every temperature between 20° C. and 250° C.
   DAFe67. The film according to any of embodiments DAFe1 to DAFe63, wherein the damping adhesive exhibits a tan delta of at least 0.53 for every temperature between 20° C. and 250° C.
   DAFe68. The film according to any of embodiments DAFe48-DAFe67 wherein tan delta is measured by dynamic mechanical analysis.
   DAFe69. The film according to any of embodiments DAFe1 to DAFe68 wherein the damping adhesive exhibits shear adhesion to stainless steel at 1000 gram test weight and 70° C. of greater than 2000 minutes.
   DAFe70. The film according to any of embodiments DAFe1 to DAFe68 wherein the damping adhesive exhibits shear adhesion to stainless steel at 1000 gram test weight and 70° C. of greater than 4000 minutes.
   DAFe71. The film according to any of embodiments DAFe1 to DAFe68 wherein the damping adhesive exhibits shear adhesion to stainless steel at 1000 gram test weight and 70° C. of greater than 6000 minutes.
   DAFe72. The film according to any of embodiments DAFe1-DAFe71 having modulus (G′) at 25° C. of less than 100,000 Pa.
   DAFe73. The film according to any of embodiments DAFe1 to DAFe72, wherein the damping adhesive exhibits a tan delta of at least 0.30 at −40° C.
   DAFe74. The film according to any of embodiments DAFe1 to DAFe72, wherein the damping adhesive exhibits a tan delta of at least 0.40 at −40° C.
   DAFe75. The film according to any of embodiments DAFe1 to DAFe72, wherein the damping adhesive exhibits a tan delta of at least 0.45 at −40° C.
   DAFe76. The film according to any of embodiments DAFe1 to DAFe72, wherein the damping adhesive exhibits a tan delta of at least 0.60 at −40° C.
   DAFe77. The film according to any of embodiments DAFe1 to DAFe72, wherein the damping adhesive exhibits a tan delta of at least 0.90 at −40° C.
   DAFp1. A film having a thickness of greater than 5 microns and less than 60 microns comprising a damping adhesive obtained by crosslinking polysiloxane(s), wherein the crosslinking is accomplished by blending into in the polysiloxane(s) a peroxide crosslinking agent in an amount equal to between 1.0% and 3.5% of the weight of the polysiloxane(s) and crosslinking the polysiloxane(s) by activating the peroxide crosslinking agent, wherein polysiloxane(s) means a polysiloxane or mixture of polysiloxanes, wherein the polysiloxane(s) include:
40-80 combined wt % (based on total weight of polysiloxane(s)) of M and Q units, and
5-20 wt % (based on total weight of polysiloxane(s)) of diphenylsiloxane units according to the formula —Si(Ph)₂—O—.
   DAFp2. The film according to embodiment DAFp1 having a thickness of greater than 7 microns.
   DAFp3. The film according to embodiment DAFp1 or DAFp2 having a thickness of less than 45 microns.
   DAFp4. The film according to embodiment DAFp1 or DAFp2 having a thickness of less than 20 microns.
   DAFp5. The film according to embodiment DAFp1 or DAFp2 having a thickness of less than 17 microns.
   DAFp6. The film according to DAFp1 or DAFp2 having a thickness of less than 15 microns.
   DAFp7. The film according to DAFp1 or DAFp2 having a thickness of less than 14 microns.
   DAFp8. The film according to DAFp1 or DAFp2 having a thickness of less than 13 microns.
   DAFp9. The film according to any of embodiments DAFp1 to DAFp8 wherein the polysiloxane(s) include:
5-35 wt % (based on total weight of polysiloxane(s)) of dimethylsiloxane units according to the formula —Si(Me)₂—O—.
   DAFp10. The film according to any of embodiments DAFp1 to DAFp9 wherein the polysiloxane(s) comprises a MQ polysiloxane and a linear polysiloxane, where the linear polysiloxane comprises diphenylsiloxane and dimethylsiloxane units.
   DAFp11. The film according to any of embodiments DAFp1 to DAFp9 wherein the polysiloxane(s) comprises a MQ polysiloxane, a first linear polysiloxane, and a second linear polysiloxane different in composition from the first linear polysiloxane, wherein the first linear polysiloxane comprises diphenylsiloxane and dimethylsiloxane units.
   DAFp12. The film according to any of embodiments DAFp1 to DAFp9 wherein the polysiloxane(s) comprises a first MQ polysiloxane, a second MQ polysiloxane different in composition from the first MQ polysiloxane, a first linear polysiloxane, and a second linear polysiloxane different in composition from the first linear polysiloxane, wherein the first linear polysiloxane comprises diphenylsiloxane and dimethylsiloxane units.
   DAFp13. The film according to any of embodiments DAFp1 to DAFp12 wherein the polysiloxane(s) include:
60-80 combined wt % (based on total weight of polysiloxane(s)) of M and Q units.
   DAFp14. The film according to any of embodiments DAFp1 to DAFp12 wherein the polysiloxane(s) include:
62-78 combined wt % (based on total weight of polysiloxane(s)) of M and Q units.
   DAFp15. The film according to any of embodiments DAFp1 to DAFp12 wherein the polysiloxane(s) include:
64-76 combined wt % (based on total weight of polysiloxane(s)) of M and Q units.
   DAFp16. The film according to any of embodiments DAFp1 to DAFp12 wherein the polysiloxane(s) include:
66-74 combined wt % (based on total weight of polysiloxane(s)) of M and Q units.
   DAFp17. The film according to any of embodiments DAFp1 to DAFp12 wherein the polysiloxane(s) include:
68-72 combined wt % (based on total weight of polysiloxane(s)) of M and Q units.
   DAFp18. The film according to any of embodiments DAFp1 to DAFp17 wherein the polysiloxane(s) include:
at least 6 wt % (based on total weight of polysiloxane(s)) of diphenylsiloxane units according to the formula —Si(Ph)₂—O—.
   DAFp19. The film according to any of embodiments DAFp1 to DAFp17 wherein the polysiloxane(s) include:
at least 7 wt % (based on total weight of polysiloxane(s)) of diphenylsiloxane units according to the formula —Si(Ph)₂—O—.
   DAFp20. The film according to any of embodiments DAFp1 to DAFp17 wherein the polysiloxane(s) include:
not more than 15 wt % (based on total weight of polysiloxane(s)) of diphenylsiloxane units according to the formula —Si(Ph)₂—O—.
   DAFp21. The film according to any of embodiments DAFp1 to DAFp17 wherein the polysiloxane(s) include:
not more than 12 wt % (based on total weight of polysiloxane(s)) of diphenylsiloxane units according to the formula —Si(Ph)₂—O—.
   DAFp22. The film according to any of embodiments DAFp1 to DAFp17 wherein the polysiloxane(s) include:
not more than 10 wt % (based on total weight of polysiloxane(s)) of diphenylsiloxane units according to the formula —Si(Ph)₂—O—.
   DAFp23. The film according to any of embodiments DAFp1 to DAFp17 wherein the polysiloxane(s) include:
not more than 9.5 wt % (based on total weight of polysiloxane(s)) of diphenylsiloxane units according to the formula —Si(Ph)₂—O—.
   DAFp24. The film according to any of embodiments DAFp1 to DAFp17 wherein the polysiloxane(s) include:
not more than 9 wt % (based on total weight of polysiloxane(s)) of diphenylsiloxane units according to the formula —Si(Ph)₂—O—.
   DAFp25. The film according to any of embodiments DAFp1 to DAFp24 wherein the peroxide crosslinking agent is activated by heat.
   DAFp26. The film according to any of embodiments DAFp1 to DAFp25 wherein the peroxide crosslinking agent is benzoyl peroxide.
   DAFp27. The film according to any of embodiments DAFp1 to DAFp26 wherein the peroxide crosslinking agent is present in the polysiloxane(s) in an amount equal to between 2.3% and 3.5% of the weight of the polysiloxane(s).
   DAFp28. The film according to any of embodiments DAFp1 to DAFp26 wherein the peroxide crosslinking agent is present in the polysiloxane(s) in an amount equal to between 2.3% and 3.3% of the weight of the polysiloxane(s).
   DAFp29. The film according to any of embodiments DAFp1 to DAFp26 wherein the peroxide crosslinking agent is present in the polysiloxane(s) in an amount equal to between 2.7% and 3.3% of the weight of the polysiloxane(s).
   DAFp30. The film according to any of embodiments DAFp1 to DAFp29 wherein the damping adhesive comprises no segments derived from acrylate monomers.
   DAFp31. The film according to any of embodiments DAFp1 to DAFp30 wherein the damping adhesive exhibits a tan delta of at least 0.42 for every temperature between 20° C. and 200° C., and wherein the damping adhesive exhibits a tan delta at 200° C. that is no more than 0.08 greater than the minimum tan delta measured in the range of 20° C. to 200° C.
   DAFp32. The film according to any of embodiments DAFp1 to DAFp30 wherein the damping adhesive exhibits a tan delta of at least 0.42 for every temperature between 20° C. and 200° C., and wherein the damping adhesive exhibits a tan delta at 200° C. that is no more than 0.07 greater than the minimum tan delta measured in the range of 20° C. to 200° C.
   DAFp33. The film according to any of embodiments DAFp1 to DAFp30 wherein the damping adhesive exhibits a tan delta of at least 0.42 for every temperature between 20° C. and 200° C., and wherein the damping adhesive exhibits a tan delta at 200° C. that is no more than 0.06 greater than the minimum tan delta measured in the range of 20° C. to 200° C.
   DAFp34. The film according to any of embodiments DAFp1 to DAFp30 wherein the damping adhesive exhibits a tan delta of at least 0.42 for every temperature between 20° C. and 200° C., and wherein the damping adhesive exhibits a tan delta at 200° C. that is no more than 0.05 greater than the minimum tan delta measured in the range of 20° C. to 200° C.
   DAFp35. The film according to any of embodiments DAFp1 to DAFp30 wherein the damping adhesive exhibits a tan delta of at least 0.42 for every temperature between 20° C. and 200° C., and wherein the damping adhesive exhibits a tan delta at 200° C. that is no more than 0.04 greater than the minimum tan delta measured in the range of 20° C. to 200° C.
   DAFp36. The film according to any of embodiments DAFp1 to DAFp30 wherein the damping adhesive exhibits a tan delta of at least 0.42 for every temperature between 20° C. and 200° C., and wherein the damping adhesive exhibits a tan delta at 200° C. that is no more than 0.03 greater than the minimum tan delta measured in the range of 20° C. to 200° C.
   DAFp37. The film according to any of embodiments DAFp1 to DAFp30 wherein the damping adhesive exhibits a tan delta of at least 0.42 for every temperature between 20° C. and 200° C., and wherein the damping adhesive exhibits a tan delta at 200° C. that is no more than 0.02 greater than the minimum tan delta measured in the range of 20° C. to 200° C.
   DAFp38. The film according to any of embodiments DAFp1 to DAFp30 wherein the damping adhesive exhibits a tan delta of at least 0.42 for every temperature between 20° C. and 200° C., and wherein the damping adhesive exhibits a tan delta at 200° C. that is no more than 0.01 greater than the minimum tan delta measured in the range of 20° C. to 200° C.
   DAFp39. The film according to any of embodiments DAFp1 to DAFp38 wherein the damping adhesive exhibits a tan delta of at least 0.42 for every temperature between 20° C. and 250° C., and wherein the damping adhesive exhibits a tan delta at 250° C. that is no more than 0.20 greater than the minimum tan delta measured in the range of 20° C. to 250° C.
   DAFp40. The film according to any of embodiments DAFp1 to DAFp38 wherein the damping adhesive exhibits a tan delta of at least 0.42 for every temperature between 20° C. and 250° C., and wherein the damping adhesive exhibits a tan delta at 250° C. that is no more than 0.17 greater than the minimum tan delta measured in the range of 20° C. to 250° C.
   DAFp41. The film according to any of embodiments DAFp1 to DAFp38 wherein the damping adhesive exhibits a tan delta of at least 0.42 for every temperature between 20° C. and 250° C., and wherein the damping adhesive exhibits a tan delta at 250° C. that is no more than 0.13 greater than the minimum tan delta measured in the range of 20° C. to 250° C.
   DAFp42. The film according to any of embodiments DAFp1 to DAFp38 wherein the damping adhesive exhibits a tan delta of at least 0.42 for every temperature between 20° C. and 250° C., and wherein the damping adhesive exhibits a tan delta at 250° C. that is no more than 0.10 greater than the minimum tan delta measured in the range of 20° C. to 250° C.
   DAF43. The film according to any of embodiments DAFp1 to DAFp38 wherein the damping adhesive exhibits a tan delta of at least 0.42 for every temperature between 20° C. and 250° C., and wherein the damping adhesive exhibits a tan delta at 250° C. that is no more than 0.08 greater than the minimum tan delta measured in the range of 20° C. to 250° C.
   DAFp44. The film according to any of embodiments DAFp1 to DAFp43 wherein the damping adhesive exhibits a tan delta of at least 0.45 for every temperature between 20° C. and 250° C.
   DAFp45. The film according to any of embodiments DAFp1 to DAFp43 wherein the damping adhesive exhibits a tan delta of at least 0.48 for every temperature between 20° C. and 250° C.
   DAFp46. The film according to any of embodiments DAFp1 to DAFp43 wherein the damping adhesive exhibits a tan delta of at least 0.51 for every temperature between 20° C. and 250° C.
   DAFp47. The film according to any of embodiments DAFp1 to DAFp43 wherein the damping adhesive exhibits a tan delta of at least 0.53 for every temperature between 20° C. and 250° C.
   DAFp48. The film according to any of embodiments DAFp31 to DAFp47 wherein tan delta is measured by dynamic mechanical analysis.
   DAFp49. The film according to any of embodiments DAFp1 to DAFp48 wherein the damping adhesive exhibits shear adhesion to stainless steel at 1000 gram test weight and 70° C. of greater than 2000 minutes.
   DAFp50. The film according to any of embodiments DAFp1 to DAFp48 wherein the damping adhesive exhibits shear adhesion to stainless steel at 1000 gram test weight and 70° C. of greater than 4000 minutes.
   DAFp51. The film according to any of embodiments DAFp1 to DAFp48 wherein the damping adhesive exhibits shear adhesion to stainless steel at 1000 gram test weight and 70° C. of greater than 6000 minutes.
   DAFp52. The film according to any of embodiments DAFp1-DAFp51 having modulus (G′) at 25° C. of less than 100,000 Pa.
   DAFp53. The film according to any of embodiments DAFp1 to DAFp52 wherein the damping adhesive exhibits a tan delta of at least 0.30 at −40° C.
   DAFp54. The film according to any of embodiments DAFp1 to DAFp52 wherein the damping adhesive exhibits a tan delta of at least 0.40 at −40° C.
   DAFp55. The film according to any of embodiments DAFp1 to DAFp52 wherein the damping adhesive exhibits a tan delta of at least 0.45 at −40° C.
   DAFp56. The film according to any of embodiments DAFp1 to DAFp52 wherein the damping adhesive exhibits a tan delta of at least 0.60 at −40° C.
   DAFp57. The film according to any of embodiments DAFp1 to DAFp52 wherein the damping adhesive exhibits a tan delta of at least 0.90 at −40° C.
   MDM1. A microspeaker diaphragm material comprising two or more stiff layers and at least one damping layer, wherein the damping layer is the film according to any of the preceding embodiments, and wherein each face of each damping layer is directly bound to a stiff layer.
   MDM2. The microspeaker diaphragm material according to embodiment MDM1 wherein each stiff layer has a thickness independently chosen from thicknesses greater than 1 micron and less than 10 microns.
   MDM3. The microspeaker diaphragm material according to embodiment MDM1 wherein each stiff layer has a thickness independently chosen from thicknesses greater than 3 microns and less than 8 microns.
   MDM4. The microspeaker diaphragm material according to any of embodiments MDM1-MDM3 wherein each stiff layer comprises material independently chosen from the group consisting of high temperature engineering thermoplastics.

MDM5. The microspeaker diaphragm material according to any of embodiments MDM1-MDM3 wherein each stiff layer comprises material independently chosen from the group consisting of polybenzimidazoles, polyamide-imides, polyimides, liquid crystal polymers, polyether sulfones, polyphenyl sulfones, polyetherimides, polyether ether ketones, and polysulfones.

MDM6. The microspeaker diaphragm material according to any of embodiments MDM1-MDM3 wherein each stiff layer comprises a polyether ether ketone.
MDM7. The microspeaker diaphragm material according to any of embodiments MDM1-MDM6 comprising two stiff layers and one damping layer.
MDM8. The microspeaker diaphragm material according to any of embodiments MDM1-MDM6 comprising three stiff layers alternating with two damping layers.
MDM9. The microspeaker diaphragm material according to any of embodiments MDM1-MDM6 comprising four stiff layers alternating with three damping layers.
MDM10. A microspeaker diaphragm made from the microspeaker diaphragm material according to any of embodiments MDM1-MDM9.
MDM11. A microspeaker comprising the microspeaker diaphragm of embodiment MDM10.
MDM12. A portable electronic device comprising the microspeaker of embodiment MDM11.
MS1. A subassembly for manufacture of a microspeaker diaphragm material comprising a stiff layer and a damping layer, wherein the damping layer is the film according to any of embodiments DAFa1-DAFa35 or DAFb1-DAFb31 or DAFe1-DAFe77 or DAFp1-DAFp57, and wherein a first face of the damping layer is directly bound to the stiff layer.
MS2. The subassembly according to embodiment MS1 wherein the stiff layer has a thickness of greater than 1 micron and less than 10 microns.
MS3. The subassembly according to embodiment MS1 wherein the stiff layer has a thickness of greater than 3 microns and less than 8 microns.
MS4. The subassembly according to any of embodiments MS1-MS3 wherein the stiff layer comprises a material chosen from the group consisting of high temperature engineering thermoplastics.
MS5. The subassembly according to any of embodiments MS1-MS3 wherein the stiff layer comprises a material chosen from the group consisting of polybenzimidazoles, polyamide-imides, polyimides, liquid crystal polymers, polyether sulfones, polyphenyl sulfones, polyetherimides, polyether ether ketones, and polysulfones.
MS6. The subassembly according to any of embodiments MS1-MS3 wherein the stiff layer comprises a polyether ether ketone.
MS7. The subassembly according to any of embodiments MS1-MS6 wherein the damping layer has a second face opposite the first face, wherein the second face bears a liner layer.
MS8. The subassembly according to embodiment MS7 wherein the liner layer bears a release layer contacting the damping layer.
MS9. The subassembly according to embodiment MS8 wherein the release layer comprises a fluorosilicone polymer.
TT1. A transfer tape comprising the film according to any of embodiments DAFa1-DAFa35 or DAFb1-DAFb31 or DAFe1-DAFe77 or DAFp1-DAFp57, wherein a first face of the film bears a liner layer.
TT2. The transfer tape according to embodiment TT1 wherein the liner layer has a first face which bears a first release layer which is in contact with the film.
TT3. The transfer tape according to embodiment TT2 wherein the first release layer comprises a first fluorosilicone polymer.
TT4. The transfer tape according to any of embodiments TT1-TT3 wherein the liner layer has a second face opposite the first face which bears a second release layer.
TT5. The transfer tape according to embodiment TT4 wherein the second release layer comprises a second fluorosilicone polymer.
TT6. The transfer tape according to any of embodiments TT4-TT5 wherein one of the first release layer and the second release layer is more easily separated from the film than the other.
TT7. The transfer tape according to embodiment TT5 wherein first fluorosilicone polymer and the second fluorosilicone polymer differ in composition.

Objects and advantages of this disclosure are further illustrated by the following examples, but the particular materials and amounts thereof recited in these examples, as well as other conditions and details, should not be construed to unduly limit this disclosure.

### EXAMPLES

Unless otherwise noted, all reagents were obtained or are available from Aldrich Chemical Co., Milwaukee, Wis., or may be synthesized by known methods.

### Test Methods

Shear Adhesion Strength at 70° C. with 1000 gram Weight

Shear adhesion strength at 70° C. was measured according to ASTM D3654/D 3654M-06: “Standard Test Methods for Shear Adhesion of Pressure Sensitive Tapes” (Reapproved 2011) with testing conducted at 70° C. The adhesive was laminated to primed 0.002 inch (51 micrometer) polyester film. Tape samples measuring 25.4 millimeters (1.0 inches) by 15.2 centimeters (6.0 inches) were cut. The tape samples were then applied to a stainless steel panel previously wiped clean with methyl ethyl ketone (MEK), then acetone, then n-heptane using lint free tissues. The samples were then centered on the panels and adhered to one end such that tape overlapped the panel by 25.4 millimeters (1 inch) in the lengthwise direction. The tape sample was then rolled down twice in each direction using a 2 kilogram (4.4 pounds) rubber roller at 12 inches/minute. The free end of the tape was folded over and adhered to itself such that there was no exposed adhesive. This free end was folded over and around a hanging hook and stapled together to secure the hook in place. The resulting panel/tape/weight assembly was suspended vertically in a stand at an angle of 2 degrees to ensure a shear failure mode in a 70° C. chamber. After 10 minutes of temperature equilibration, a 1.0 kilogram (2.2 pounds) weight was attached to the hook and the time, in minutes, for the tape to fall from the panel was recorded. The test was terminated if failure had not occurred by 10,000 minutes and the result recorded as “>10,000”. The average of two samples was reported.

Shear Adhesion Strength at 70° C. with 500 gram Weight

As PEEK itself will distort and fail under a 1 kg load at 70° C., some testing was conducted with a 500 gram load, as indicated in Table 3. The above process was performed with the following modifications: The adhesive was laminated to an 8 micrometer thick PEEK film rather than the polyester film. A 500 gram load was used in place of the 1000 gram load.

### Dynamic Mechanical Analysis (DMA)

Dynamic mechanical analysis was used to measure the storage modulus and glass transition temperatures of adhesives. A rheometer (Model ARES G2 RHEOMETER, TA Instruments, New Castle, Del.) having parallel top and bottom plates, each having a diameter of 8 millimeters was used. An adhesive sample in the form of a circular disk having a diameter of 8 millimeters and a thickness of approximately 1 millimeter was transferred onto the bottom plate of the rheometer. The top plate of the rheometer was brought down onto the adhesive sample and the sample was subjected to oscillatory shear while being heated from 0° C.-250° C. at a rate of 3° C./minute at a frequency of 1 Hertz and an initial strain amplitude of 1% with autostrain enabled. For autostrain, the minimum torque is 4.0 g-cm, the maximum allowed torque is 150.0 g-cm, and the strain adjustment is 50% of the current strain. Select samples were tested while being heated from −40° C. to 250° C. all other parameters the same. Storage modulus (G′) and Loss Modulus (G″) data was collected over the entire temperature range and reported in Pascals. Tan delta was calculated as the ratio of (loss modulus/storage modulus)=(G″/G′). The temperature at which the tan delta curve exhibited a local peak was reported as the glass transition temperature (Tg) in ° C. G′ and tan delta at various temperatures including the minimum tan delta are reported in the tables.

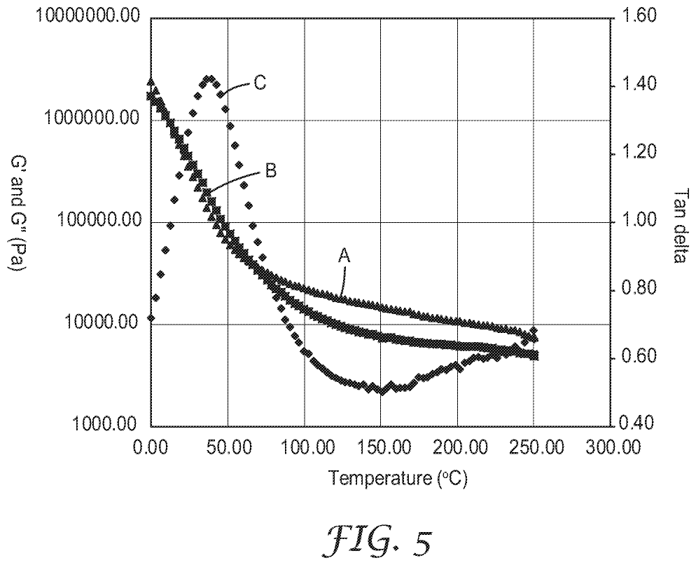

FIG. 5 is a graph presenting dynamic mechanical analysis data measured for Example 4. Line A represents G′ and line B represents G″, both referencing the left-hand scale. Line C represents tan delta, referencing the right-hand scale.

### Materials

| Designation | Description |
|---|---|
| Q2-7735 | Dow Corning ® Q2-7735 Adhesive is a peroxide-curable |
| | silicone pressure sensitive adhesive, that is a dispersion of |
| | siloxane gum and silicone resin diluted with xylene to 55 |
| | percent silicone solids content, and is available from Dow |
| | Corning Corporation, Midland, MI. MQ resin content is 60 |
| | wt %. Diphenyl siloxane content is zero. |
| PSA6574 | PSA6574 silicone pressure sensitive adhesive is a toluene |
| | solution of phenyl based polysiloxane gum and MQ resin. It |
| | is supplied at 55 percent silicone solids unless otherwise |
| | noted and may be further diluted with aromatic, aliphatic or |
| | chlorinated solvents and is available from Momentive |
| | Performance Materials, Waterford, NY. Analysis by NMR |
| | spectroscopy indicates that the polysiloxane content of |
| | PSA6574 includes 69.8 wt % MQ resin and 8.4 wt % |
| | diphenyl siloxane units, with the remainder dimethyl- |
| | siloxane units. |
| 7956 | Dow Coming ® 7956 Pressure Sensitive Adhesive is a |
| | dispersion of polydiphenyldimethyl siloxane copolymer |
| | gum and MQ resin in solvent with solids of 54-58% and |
| | viscosity of 20,000-80,000 cP, and is available from Dow |
| | Corning Corporation, Midland, MI. Analysis by NMR |
| | spectroscopy indicates that the polysiloxane content of |
| | 7956 includes 64.4 wt % MQ resin and 1.8 wt % diphenyl |
| | siloxane units. |
| DC 200 | Dow Corning ®200 Fluid 300,000 CSt polydimethyl- |
| | siloxane CAS # 63148-62-9 and is available from Dow |
| | Corning Corporation, Midland, MI. |
| SF 1230 | Andisil ® SF 1230 is a specialty silicone methyl-phenyl |
| | fluid with a refractive index of 1.4630, and a viscosity |
| | of 13,000 cSt. Andisil ® Methyl Phenyl Fluids are |
| | trimethylsiloxyterminated dimethyl diphenyl polysiloxanes |
| | and are available from AB Specialty Silicones, Waukegan, |
| | IL. Content of diphenyl siloxane units is 28.6 wt %. |
| PDM-1922 | PDM-1922 is a liquid diphenylsiloxane-dimethylsiloxane |
| | copolymer (CAS # 68083-14-7) with a refractive index of |
| | 1.49, a molecular mass of 1600-2400 grams/mol, and a |
| | reported 20 mol % diphenyl siloxane content (calculated |
| | to be 40 wt % diphenyl siloxane content), available from |
| | Gelest, Inc., Morrisville, PA. |
| 88778 | 88778 Gum is a diphenylsiloxane-dimethylsiloxane co- |
| Gum | polymer with 28.6 wt % diphenyl siloxane and 71.4% wt % |
| | dimethylsiloxane determined by NMR analysis and Mn of |
| | 5.11E+04 and Mw of 7.52E+05 determined by GPC |
| | analysis, obtained from Momentive Performance Materials, |
| | Waterford, NY. |
| Luperox ® | Luperox ® A75 benzoyl peroxide (CAS#94-36-0) is 75% |
| A75 | active benzoyl peroxide (BPO) with 25% remainder water |
| | added for added safety used in polymerizations and |
| | crosslinking reactions and is available from Sigma- |
| | Aldrich, Milwaukee, WI. |
| PSA 518 | PSA518 silicone pressure sensitive adhesive is a xylene |
| | solution of phenyl based polysiloxane gum and resin. It is |
| | supplied at 56% solids and a viscosity of 65,000 cP, and is |
| | available from Momentive Performance Materials, |
| | Waterford, NY. The polysiloxane content of PSA518 |
| | includes 72.6 wt % MQ resin and 1.6 wt % diphenyl |
| | siloxane units. |
| SF 82001 | SILFLU S 50 M 1R82001 CLEAR is a 0.002 inches (51 |
| | micrometers) polyester liner with a fluororsilicone release |
| | coating on one side, available from SILICONATURE USA |
| | LLC, Chicago, IL. |
| SF 88001 | SILFLU S 50 M 1R88001 CLEAR is a 0.002 inches (51 |
| | micrometers) polyester liner with a fluororsilicone release |
| | coating on one side, available from SILICONATURE USA |
| | LLC, Chicago, IL. |
| L5192 | Loparex 5192 is a 0.002 inches (51 micrometers) polyester |
| | liner that has a fluorosilicone release coating on one side |
| | and is available from LOPAREX LLC. Cary N.C. |
| L5104 | Loparex 5104 is a 0.002 inches (51 micrometers) polyester |
| | liner that has a fluorosilicone release coating on one side. |
| | LOPAREX LLC. Cary N.C. |
| 1022 | 3M SCOTCHPAK 1022 fluorosilicone treated polyester |
| | release liner, 0.003 inches (76 micrometers) thick, |
| | available from 3M Company, Saint Paul, MN |
| PEEK | 8 micrometer thick APTIV PEEK 1000, a thermoplastic |
| | polyether ether ketone film, available from Victrex plc, |
| | Lancanshire, United Kingdom. |
| DCBPO | Perkadox PD-50S-PS is Di (2,4-dichlorobenzoyl) peroxide |
| paste | (CAS No. 133-14-2) prepared as an off-white homogeneous |
| | paste (50% peroxide in silicone oil) used for crosslinking |
| | of silicone rubbers, available from Akzo-Nobel Polymer |
| | Chemistry, Chicago, IL. |

### EXAMPLES AND COMPARATIVE EXAMPLES

### Preparation of 7% Benzoyl Peroxide Solution

Luperox® A75 was used to make the BPO solution in Toluene. 28.00 g of Luperox® A75 and 279.02 g of Toluene were added to a 500 g glass jar and the mixture was rolled for 50 min on a roller. The pure BPO is extracted into the Toluene while the water was visible in the bottom of the jar. The BPO solution in the upper part of the mixture was decanted in to another 500 g glass jar and some of the solution was left with the water to make sure no water is transferred into the new glass jar.

A ˜300 g solution of 7% BPO in Toluene was obtained. Fresh BPO in toluene was prepared for each example or comparative example when required; the solution was not used if over 8 hours old.

### Preparation of 5% Benzoyl Peroxide Solution

Luperox® A75 was used to make the BPO solution in Toluene. 35.00 g of Luperox® A75 and 498.76 g of Toluene were added to a 1000 g glass jar and the mixture was rolled for 50 min on a roller. The pure BPO is extracted into the Toluene while the water was visible in the bottom of the jar. The BPO solution in the upper part of the mixture was decanted in to another 500 g glass jar and some of the solution was left with the water to make sure no water is transferred into the new glass jar.

A ˜500 g solution of 5% BPO in Toluene was obtained. Fresh BPO in toluene was prepared for each example or comparative example when required; the solution was not used if over 8 hours old.

### Preparation of 20% Di (2,4-Dichlorobenzoyl) Peroxide Solution

To a 100 milliliter jar was added 10.0 grams of DCBPO paste and 15.0 grams of toluene. The jar was sealed and placed on a mechanical roller for one hour to give 20.0% Di (2,4-dichlorobenzoyl) peroxide in (silicone/MEK) solution.

### Comparative Example 1

20.0 grams of Q2-7735 solution was coated by hand onto the release treated side of a fluorosilicone liner, SF 88001, using a notchbar coater having a gap setting of 0.008 inches (400 micrometers) greater than the thickness of the liner and a speed of 3 feet/minute (91 centimeters/minute). Solvent removal and crosslinking of the coated adhesive was carried out in the following manner. First, the coated liner was allowed to sit at room temperature for 15 minutes; next, it was attached to a metal sheet and placed in an oven at 194° F. (90° C.) for five minutes; and finally the assembly was placed in an oven at 338° F. (170° C.) for three minutes. An adhesive transfer tape having an adhesive layer with a thickness of approximately 41 micrometers on a release liner was obtained.

### Comparative Example 2

To a 500 milliliter jar were added 200.0 grams of Q-7735 and 194.5 grams of toluene. The jar was sealed and placed on a mechanical roller for one hour to give a 27.9% solids (w:w) solution. To this solution was added 49.5 grams of a freshly prepared 7% Benzoyl Peroxide Solution, made as described above. The jar was once again sealed and placed on a mechanical roller, this time for 15 minutes, to give a homogenous solutions containing 25.6% (w:w) solids. This solution contained Q2-7735:BPO/97:3 (w:w). This solution was coated onto the release treated side of a 13 inch (33 centimeters) wide fluorosilicone liner, SF 88001, using a notchbar coater having a gap setting of 0.004 inches (102 micrometers) greater than the thickness of the liner followed by passing the coated liner through an oven having three zones set at the following temperatures: 180° F., 180° F., and 300° F. (82° C., 82° C., and 149° C.) to remove solvent and crosslink the adhesive over a period of 4 minutes. A line speed of 9 feet/minute (2.74 meters/minute) was employed for the coating/drying/crosslinking process. The crosslinked adhesive surface of the resulting article was laminated to the release coated side of a second fluorosilicone liner, SF 82001, using a nip roller. An adhesive transfer tape having a crosslinked adhesive layer with a thickness of approximately 15 micrometers between two different release liners was obtained.

### Comparative Example 3

Comparative Example 1 was repeated with the following modification. The adhesive was e-beamed with a dose of 4 Mrad at 240 kV at 24.1 fpm under a nitrogen atmosphere.

### Comparative Example 4

Comparative Example 1 was repeated with the following modification. The adhesive was e-beamed with a dose of 8 Mrad at 240 kV at 24.1 fpm under a nitrogen atmosphere.

### Comparative Example 5

To a one gallon jar were added 600.0 grams of PSA 6574 and 450 grams of toluene. The jar was sealed and placed on a mechanical roller for one hour to give a 32.0% solids (w:w) solution. This solution was coated onto the release treated side of a 13 inch (33 centimeters) wide fluorosilicone liner, L5192, using a notchbar coater having a gap setting of 0.003 inches (76 micrometers) greater than the thickness of the liner followed by passing the coated liner through an oven having three zones set at the following temperatures: 180° F., 180° F., and 302° F. (82° C., 82° C., and 150° C.) over a period of four minutes to remove solvent. A line speed of 9 feet/minute (2.74 meters/minute) was employed for the coating/drying process. The adhesive surface of the resulting article was laminated to the release coated side of a second fluorosilicone liner, SF 82001, using a nip roller. An adhesive transfer tape having an adhesive layer with a thickness of approximately 16 micrometers between two different release liners was obtained.

### Comparative Example 6

Comparative Example 5 was repeated with the following modification. The SF 82001 liner was removed and the adhesive was e-beamed with a dose of 7 Mrad at 240 kV at 24.1 fpm under a nitrogen atmosphere.

### Comparative Example 7

To a one gallon jar were added 274.4 grams of PSA 6574 and 156.4 grams of toluene. The jar was sealed and placed on a mechanical roller for one hour to give a 35.7% solids (w:w) solution. To this solution was added 93.3 grams of toluene and 44.1 grams of a freshly prepared 7% Benzoyl Peroxide Solution, made as described above. The jar was once again sealed and placed on a mechanical roller, this time for 15 minutes, to give a homogenous solutions containing 27.6% (w:w) solids. This solution contained PSA 6574:BPO/98:2 (w:w). This solution was coated onto the release treated side of a 13 inch (33 centimeters) wide fluorosilicone liner, L5192, using a notchbar coater having a gap setting of 0.004 inches (102 micrometers) greater than the thickness of the liner followed by passing the coated liner through an oven having three zones set at the following temperatures: 176° F., 176° F., and 300° F. (80° C., 80° C., and 149° C.) to remove solvent and crosslink the adhesive over a period of 4 minutes. A line speed of 9 feet/minute (2.74 meters/minute) was employed for the coating/drying/crosslinking process. The crosslinked adhesive surface of the resulting article was laminated to the release coated side of a second fluorosilicone liner, SF 82001, using a nip roller. An adhesive transfer tape having a crosslinked adhesive layer with a thickness of approximately 11 micrometers between two different release liners was obtained.

### Comparative Example 8

To a one gallon jar were added 400.2 grams of PSA 6574 and 224.5 grams of toluene. The jar was sealed and placed on a mechanical roller for one hour to give a 35.9% solids (w:w) solution. To this solution was added 89.6 grams of a freshly prepared 5% Benzoyl Peroxide Solution, made as described above. The jar was once again sealed and placed on a mechanical roller, this time for 15 minutes, to give a homogenous solutions containing 32% (w:w) solids. This solution contained PSA 6574:BPO/98:2 (w:w). This solution was coated onto the release treated side of a 13 inch (33 centimeters) wide fluorosilicone liner, L5192, using a notchbar coater having a gap setting of 0.004 inches (102 micrometers) greater than the thickness of the liner followed by passing the coated liner through an oven having three zones set at the following temperatures: 180° F., 200° F., and 350° F. (82° C., 93° C., and 177° C.) to remove solvent and crosslink the adhesive over a period of 4 minutes. A line speed of 9 feet/minute (2.74 meters/minute) was employed for the coating/drying/crosslinking process. The crosslinked adhesive surface of the resulting article was laminated to the release coated side of a second fluorosilicone liner, SF 82001, using a nip roller. An adhesive transfer tape having a crosslinked adhesive layer with a thickness of approximately 11 micrometers between two different release liners was obtained.

### Comparative Example 9

A coating solution was prepared by adding the following materials to a MAX 40 SPEEDMIXER cup (FlackTek, Incorporated, Landrum, S.C.): 25.1 grams of PSA 518 and 10.9 grams of toluene. These were mixed at 2700 rpm for 45 seconds in a DAC 150.1 FVZ-K SPEEDMIXER (FlackTek, Incorporated, Landrum, S.C.). To this solution was added 5.1 grams of a freshly prepared 7% Benzoyl Peroxide Solution, made as described above followed by mixing for an additional 45 seconds at 2700 rpm to give a homogenous solutions containing 35% (w:w) solids. This solution contained PSA 518:BPO/97.5:2.5 (w:w). This solution was coated by hand onto the release treated side of a fluorosilicone liner, SF 88001, using a notchbar coater having a gap setting of 0.002 inches (51 micrometers) greater than the thickness of the liner and a speed of 3 feet/minute (91 centimeters/minute). Solvent removal and crosslinking of the coated adhesive was carried out in the following manner. First, the coated liner was allowed to sit at room temperature for 10 minutes; next, it was attached to the top of a rectangular, metal frame such that the majority of the adhesive coated area was suspended above the frame and not in contact with it and the resulting assembly placed in an oven at 201° F. (94° C.) for ten minutes; and finally the assembly was placed in an oven at 320° F. (160° C.) for five minutes. An adhesive transfer tape having a crosslinked adhesive layer with a thickness of approximately 18 micrometers on a release liner was obtained.

### Comparative Example 10

PSA 518 was coated by hand onto the release treated side of a fluorosilicone liner, SF 88001, using a notchbar coater having a gap setting of 0.004 inches (102 micrometers) greater than the thickness of the liner and a speed of 3 feet/minute (91 centimeters/minute). Solvent removal of the coated adhesive was carried out in the following manner. First, the coated liner was allowed to sit at room temperature for 10 minutes; next, it was attached to a metal panel and placed in an oven at 257° F. (125° C.) for ten minutes. An adhesive transfer tape having an adhesive layer with a thickness of approximately 16 micrometers on a release liner was obtained.

### Comparative Example 11

Comparative Example 10 was repeated with the following modification. The sample was e-beamed open face with a dose of 3 Mrad, 240 kV at 24.1 fpm, under a nitrogen atmosphere. The adhesive was 16 micron thick.

### Comparative Example 12

To a one gallon jar were added 224.2 grams of 7956 and 258.7 grams of toluene. The jar was sealed and placed on a mechanical roller for one hour to give a 26.0% solids (w:w) solution. This solution was coated onto the release treated side of a 13 inch (33 centimeters) wide fluorosilicone liner, L5192, using a notchbar coater having a gap setting of 0.004 inches (102 micrometers) greater than the thickness of the liner followed by passing the coated liner through an oven having three zones set at the following temperatures: 176° F., 184° F., and 285° F. (84° C., 80° C., and 141° C.) over a period of 4 minutes to remove solvent from the adhesive. A line speed of 9 feet/minute (2.74 meters/minute) was employed for the coating/drying process. The adhesive surface of the resulting article was laminated to the release coated side of SF 82001, using a nip roller. An adhesive transfer tape having an adhesive layer with a thickness of approximately 14 micrometers between two different release liners was obtained. Over time some liner confusion was observed.

### Comparative Example 13

Comparative Example 12 was repeated with the following modification. A freshly prepared sample was e-beamed through the SF 82001 liner with a dose of 3 Mrad at 240 kV at 24.1 fpm, under a nitrogen atmosphere.

### Comparative Example 14

To a one gallon jar were added 224.9 grams of 7956 and 262.9 grams of toluene. The jar was sealed and placed on a mechanical roller for 45 minutes to give a 25.8% solids (w:w) solution. To this solution was added 46.2 grams of a freshly prepared 7% Benzoyl Peroxide Solution, made as described above. The jar was once again sealed and placed on a mechanical roller, this time for 15 minutes, to give a homogenous solutions containing 24.2% (w:w) solids. This solution contained 7956:BPO/97.5:2.5 (w:w). This solution was coated onto the release treated side of a 13 inch (33 centimeters) wide fluorosilicone liner, L5104, using a notchbar coater having a gap setting of 0.004 inches (102 micrometers) greater than the thickness of the liner followed by passing the coated liner through an oven having three zones set at the following temperatures: 176° F., 176° F., and 302° F. (80° C., 80° C., and 150° C.) to remove solvent and crosslink the adhesive over a period of 4 minutes. A line speed of 9 feet/minute (2.74 meters/minute) was employed for the coating/drying/crosslinking process. The crosslinked adhesive surface of the resulting article was laminated to the release coated side of a second fluorosilicone liner, 1022, using a nip roller. An adhesive transfer tape having a crosslinked adhesive layer with a thickness of approximately 13 micrometers between two different release liners was obtained.

### Example 1

To a one gallon jar were added 1360 grams of PSA 6574 and 1260.9 grams of toluene. The jar was sealed and placed on a mechanical roller for one hour to give a 29.0% solids (w:w) solution. This solution was coated onto the release treated side of a 13 inch (33 centimeters) wide fluorosilicone liner, L5192, using a notchbar coater having a gap setting of 0.004 inches (102 micrometers) greater than the thickness of the liner followed by passing the coated liner through an oven having three zones set at the following temperatures: 180° F., 180° F., and 270° F. (82° C., 82° C., and 132° C.) to remove solvent over a period of 4 minutes. A line speed of 9 feet/minute (2.74 meters/minute) was employed for the coating/drying/process. The adhesive surface of the resulting article was laminated to the release coated side of a second fluorosilicone liner, SF 82001, using a nip roller. The adhesive was e-beamed through the SF 82001 liner with 3 Mrad at 240 kV at 24.1 fpm. An adhesive transfer tape having an adhesive layer with a thickness of approximately 12 micrometers between two different release liners was obtained.

### Example 2

Example 1 was repeated with the following modification. The adhesive was e-beamed through the SF 82001 liner with 3.5 Mrad, 240 kV at 24.1 fpm under a nitrogen atmosphere.

### Example 3

Part A: To a 500 milliliter jar were added 10.0 grams of DC 200 and 90.0 grams of toluene. The jar was sealed and placed on a mechanical roller for one hour to give a homogeneous 10% solids (w:w) solution.

Part B: To a one liter glass jar were added 275.2 grams of PSA 6574 and 251.6 grams of toluene. The jar was sealed and placed on a mechanical roller for one hour to give a 29.3% solids (w:w) solution. To this solution was added 50.2 grams of the solution of Part A and the jar was once again sealed and placed on a mechanical roller, this time for 45 minutes, to give a homogenous solutions containing 27.6% (w:w) solids. This solution contained PSA 6574:DC 200/96.85:3.15 (w:w). The solution was coated onto the release treated side of a 13 inch (33 centimeters) wide fluorosilicone liner, L5192, using a notchbar coater having a gap setting of 0.004 inches (102 micrometers) greater than the thickness of the liner followed by passing the coated liner through an oven having three zones set at the following temperatures: 174° F., 184° F., and 285° F. (79° C., 84° C., and 141° C.) to remove solvent over a period of 4 minutes. A line speed of 9 feet/minute (2.74 meters/minute) was employed for the coating/drying process. The adhesive surface of the resulting article was laminated to the release coated side of a second fluorosilicone liner, SF 82001, using a nip roller. An adhesive transfer tape having an adhesive layer with a thickness of approximately 12 micrometers between two different release liners was obtained. The adhesive was e-beamed through the SF 82001 liner with 3 Mrad, 240 kV at 24.1 fpm.

### Example 4

To a 500 milliliter jar were added 287.9 grams of PSA 6574 and 286.8 grams of toluene. The jar was sealed and placed on a mechanical roller for one hour to give a 28.1% solids (w:w) solution. The solution was coated onto the release treated side of a 13 inch (33 centimeters) wide fluorosilicone liner, L5192, using a notchbar coater having a gap setting of 0.004 inches (102 micrometers) greater than the thickness of the liner followed by passing the coated liner through an oven having three zones set at the following temperatures: 174° F., 184° F., and 285° F. (79° C., 84° C., and 141° C.) to remove solvent over a period of 4 minutes. A line speed of 9 feet/minute (2.74 meters/minute) was employed for the coating/drying process. The adhesive surface of the resulting article was laminated to the release coated side of a second fluorosilicone liner, SF 82001, using a nip roller. The sample was e-beamed through the SF 82001 liner with 3 Mrad at 240 kV at 24.1 fpm. An adhesive transfer tape having a crosslinked adhesive layer with a thickness of approximately 11 micrometers between two different release liners was obtained.

FIG. 5 is a graph presenting dynamic mechanical analysis data measured for Example 4. Line A represents G′ and line B represents G″, both referencing the left-hand scale. Line C represents tan delta, referencing the right-hand scale.

### Example 5

Example 4 was repeated with the following modification. The SF 82001 liner with removed and then the adhesive was e-beamed open face with 3 Mrad, 240 kV at 24.1 fpm under a nitrogen atmosphere.

### Comparative Example 15

Example 4 was repeated with the following modification. The SF 82001 liner with removed and then the adhesive was e-beamed open face with 6 Mrad, 240 kV at 24.1 fpm under a nitrogen atmosphere.

### Example 6

Example 3 was repeated with the following modifications:

Part A: To a 500 milliliter jar were added 17.8 grams of 7956 and 90.0 grams of toluene. The jar was sealed and placed on a mechanical roller for one hour to give a homogeneous 10% solids (w:w) solution.

Part B: To a one liter glass jar were added 298.5 grams of PSA 6574 and 285.8 grams of toluene. The jar was sealed and placed on a mechanical roller for one hour to give a 28.6% solids (w:w) solution. To this solution was added 25.7 grams of the solution of Part A and the jar was once again sealed and placed on a mechanical roller, this time for 45 minutes, to give a homogenous solutions containing 27.8% (w:w) solids. This solution contained PSA 6574:7956/98.5:1.5 (w:w). An adhesive transfer tape having an adhesive layer with a thickness of approximately 12 micrometers between two different release liners was obtained. The adhesive was e-beamed through the SF 82001 liner with 3 Mrad, 240 kV at 24.1 fpm.

### Example 7

Example 6 was repeated with the following modifications:

Part B: To a one liter glass jar were added 288.0 grams of PSA 6574 and 263.3 grams of toluene. The jar was sealed and placed on a mechanical roller for one hour to give a 29.3% solids (w:w) solution. To this solution was added 52.5 grams of the solution of Part A and the jar was once again sealed and placed on a mechanical roller, this time for 45 minutes, to give a homogenous solutions containing 27.6% (w:w) solids. This solution contained PSA 6574:7956/96.85:3.15 (w:w). The e-beam crosslinked adhesive between two different release liners with a thickness of 12 micrometers was obtained.

### Example 8

Part A: To a 500 milliliter jar were added 10.0 grams of DC 200 and 90.0 grams of toluene. The jar was sealed and placed on a mechanical roller for one hour to give a homogeneous 10% solids (w:w) solution.

Part B: To a one liter glass jar were added 253.8 grams of PSA 6574 and 205.8 grams of toluene. The jar was sealed and placed on a mechanical roller for one hour to give a 31.0% solids (w:w) solution. To this solution was added 50.2 grams of the solution of Part A and the jar was once again sealed and placed on a mechanical roller, this time for 45 minutes, to give a homogenous solution. Next, 45.9 grams of 7% BPO solution were added and the solution was mixed again for 15 minutes. containing 27.1% (w:w) solids. This solution contained PSA 6574:DC 200:BPO/94.6:3.3:2.1 (w:w:w). This solution was coated onto the release treated side of a 13 inch (33 centimeters) wide fluorosilicone liner, L5192, using a notchbar coater having a gap setting of 0.004 inches (102 micrometers) greater than the thickness of the liner followed by passing the coated liner through an oven having three zones set at the following temperatures: 176° F., 176° F., and 302° F. (80° C., 80° C., and 150° C.) to remove solvent and crosslink the adhesive over a period of 4 minutes. A line speed of 9 feet/minute (2.74 meters/minute) was employed for the coating/drying/crosslinking process. The adhesive surface of the resulting article was laminated to the release coated side of a second fluorosilicone liner, 1022, using a nip roller. An adhesive transfer tape having an adhesive layer with a thickness of approximately 12 micrometers between two different release liners was obtained.

### Example 9

Example 8 was repeated with the following modifications:

Part A: To a 500 milliliter jar were added 17.8 grams of 7956 and 90.0 grams of toluene. The jar was sealed and placed on a mechanical roller for one hour to give a homogeneous 10% solids (w:w) solution.

Part B: To a one liter glass jar were added 265.7 grams of PSA 6574 and 215.4 grams of toluene. The jar was sealed and placed on a mechanical roller for one hour to give a 30.9% solids (w:w) solution. To this solution was added 52.5 grams of the solution of Part A and the jar was once again sealed and placed on a mechanical roller, this time for 45 minutes, to give a homogenous solution. Next, 48.1 grams of 7% BPO solution were added and the solution was mixed again for 15 minutes. To provide a 27.1% (w:w) solids solution. This solution contained PSA 6574:7956:BPO/94.6:3.3:2.1 (w:w:w). An adhesive transfer tape having an adhesive layer with a thickness of approximately 12 micrometers between two different release liners was obtained.

### Example 10

A coating solution was prepared by adding the following materials to a MAX 40 SPEEDMIXER cup (FlackTek, Incorporated, Landrum, S.C.): 4.01 grams of PSA 6574 and 16.01 g of 7956. These were mixed at 2700 rpm for 45 seconds in a DAC 150.1 FVZ-K SPEEDMIXER (FlackTek, Incorporated, Landrum, S.C.). To this solution was added 12.01 g toluene and the solution was mixed an additional 45 seconds at 2700 rpm to give a homogenous solutions containing 35% (w:w) solids. This solution contained PSA 6574:7956/20:80 (w:w). This solution was coated by hand onto the release treated side of a fluorosilicone liner, SF 88001, using a notchbar coater having a gap setting of 0.002 inches (51 micrometers) greater than the thickness of the liner and a speed of 3 feet/minute (91 centimeters/minute). Solvent removal of the coated adhesive was carried out in the following manner. First, the coated liner was allowed to sit at room temperature for 10 minutes; next, it was attached to the top of a rectangular, metal frame such that the majority of the adhesive coated area was suspended above the frame and not in contact with it and the resulting assembly placed in an oven at 201° F. (94° C.) for ten minutes. The release treated side of a fluorosilicone liner SF 82001 was laminated to the dried exposed adhesive. An adhesive transfer tape having an adhesive layer with a thickness of approximately 12 micrometers on a release liner was obtained. The adhesive was e-beamed through the SF 82001 liner with 3 Mrad at 240 kV.

### Example 11

Example 10 was repeated with the following modifications. PEEK was laminated to the surface of the adhesive instead of the SF 82001 liner. The sample was e-beamed with 3 Mrad at 240 kV through the SF 88001 liner. The thickness of the adhesive was 12 micrometers.

### Comparative Example 16

Example 11 was repeated with the following modification. The sample was not e-beamed.

### Example 12

To a one gallon jar were added 1000.0 grams of PSA 6574 and 1153.8 grams of heptane. The jar was sealed and placed on a mechanical roller for one hour to give a 26% solids (w:w) solution. This solution was pumped through a knife coater at 18.4 cc/min with a 110 micron gap at 4 fpm, 11 inches wide onto the release treated side of 13 inch wide release liner SF 82001, followed by passing the coated liner through an oven having four zones set at the following temperatures: 176° F., 302° F., 302° F., and 302° F. (80° C., 150° C., 150° C., and 150° C.) to remove solvent from the adhesive over a period of 5 minutes. A line speed of 9 feet/minute (2.74 meters/minute) was employed for the coating/process. The adhesive surface of the resulting article was laminated to the 8 micron PEEK film, using a nip roller. An adhesive transfer tape having an adhesive layer with a thickness of approximately 11 micrometers between two different release liners was obtained. The SF 82001 liner was removed and then the adhesive was e-beamed open face with 3 Mrad, 240 kV at 24.1 fpm under a nitrogen atmosphere.

### Example 13

To a one gallon jar were added 250.4 grams of PSA 6574, 150.3 grams heptane, and 93.8 grams of toluene. The jar was sealed and placed on a mechanical roller for one hour to give a 28.4% solids (w:w) solution. To this solution was added 61.9 grams of a freshly prepared 7% Benzoyl Peroxide Solution, made as described above. The jar was once again sealed and placed on a mechanical roller, this time for 15 minutes, to give a homogenous solutions containing 26.0% (w:w) solids. This solution contained PSA 6574:BPO/97:3 (w:w). This solution was coated onto the release treated side of a 13 inch (33 centimeters) wide fluorosilicone liner, SF 88001, using a notchbar coater having a gap setting of 0.004 inches (102 micrometers) greater than the thickness of the liner followed by passing the coated liner through an oven having three zones set at the following temperatures: 176° F., 176° F., and 300° F. (80° C., 80° C., and 149° C.) to remove solvent and crosslink the adhesive over a period of 4 minutes. A line speed of 9 feet/minute (2.74 meters/minute) was employed for the coating/drying/crosslinking process. The crosslinked adhesive surface of the resulting article was laminated to the release coated side of a second fluorosilicone liner, SF 82001, using a nip roller. An adhesive transfer tape having a crosslinked adhesive layer with a thickness of approximately 13 micrometers between two different release liners was obtained.

### Example 14

To a one gallon jar were added 440.1 grams of PSA 6574, 324.4 grams of toluene, and 110.4 grams of 7956. The jar was sealed and placed on a mechanical roller for one hour to give a 35.2% solids (w:w) solution. To this solution was added 112.9 grams of a freshly prepared 7% Benzoyl Peroxide Solution, made as described above. The jar was once again sealed and placed on a mechanical roller, this time for 15 minutes, to give a homogenous solutions containing 32.0% (w:w) solids. This solution contained PSA 6574: 7956:BPO/78:19.5:2.5 (w:w:w). This solution was coated onto the release treated side of a 13 inch (33 centimeters) wide fluorosilicone liner, L5192, using a notchbar coater having a gap setting of 0.0035 inches (88 micrometers) greater than the thickness of the liner followed by passing the coated liner through an oven having three zones set at the following temperatures: 176° F., 176° F., and 300° F. (80° C., 80° C., and 149° C.) to remove solvent and crosslink the adhesive over a period of 4 minutes. A line speed of 9 feet/minute (2.74 meters/minute) was employed for the coating/drying/crosslinking process. The crosslinked adhesive surface of the resulting article was laminated to the release coated side of a second fluorosilicone liner, SF 82001, using a nip roller. An adhesive transfer tape having a crosslinked adhesive layer with a thickness of approximately 16 micrometers between two different release liners was obtained.

### Example 15

Example 1 was repeated with the following modifications.

To a one gallon jar were added 1360 grams of PSA 6574 and 1260.9 grams of toluene. The jar was sealed and placed on a mechanical roller for one hour to give a 29.0 solids (w:w) solution. This solution was coated onto the release treated side of a 13 inch (33 centimeters) wide fluorosilicone liner, SF 88001 using a notchbar coater having a gap setting of 0.002 inches (51 micrometers) greater than the thickness of the liner followed by passing the coated liner through an oven having three zones set at the following temperatures: 180° F., 180° F., and 270° F. (82° C., 82° C., and 132° C.) to remove solvent over a period of 4 minutes. A line speed of 9 feet/minute (2.74 meters/minute) was employed for the coating/drying/process. The adhesive surface of the resulting article was laminated to the release coated side of a second fluorosilicone liner, SF 82001, using a nip roller. An adhesive transfer tape having an adhesive layer with a thickness of approximately 8 micrometers between two different release liners was obtained. The adhesive was e-beamed through the SF 82001 liner with 2 Mrad at 240 kV at 24.1 fpm.

### Example 16

Example 15 was repeated with the following modification: The notchbar gap was 0.004 inches (102 micrometers).

### Example 17

To a 500 milliliter jar were added 200.2 grams of PSA 6574, 4.67 grams of Andisil SF1230 and 212.8 grams of toluene. The jar was sealed and placed on a mechanical roller over night to give a 28.0% solids (w:w) solution. To this solution was added 42.8 grams of a freshly prepared 7% Benzoyl Peroxide Solution, made as described above. The jar was once again sealed and placed on a mechanical roller, this time for 15 minutes, to give a homogenous solutions:containing 26% (w:w) solids. This solution contained PSA 6574:Andisil SF1230:BPO/93.6:3.9:2.5 (w:w:w). This solution was coated onto the release treated side of a 13 inch (33 centimeters) wide fluorosilicone liner, SF 88001, using a notchbar coater having a gap setting of 0.004 inches (102 micrometers) greater than the thickness of the liner followed by passing the coated liner through an oven having three zones set at the following temperatures: 180° F., 180° F., and 300° F. (82° C., 82° C., and 149° C.) to remove solvent and crosslink the adhesive over a period of 4 minutes. A line speed of 9 feet/minute (2.74 meters/minute) was employed for the coating/drying/crosslinking process. The crosslinked adhesive surface of the resulting article was laminated to the release coated side of a second fluorosilicone liner, SF 82001, using a nip roller. An adhesive transfer tape having a crosslinked adhesive layer with a thickness of approximately 14 micrometers between two different release liners was obtained.

### Comparative Example 17

A coating solution was prepared by adding the following materials to a MAX 40 SPEEDMIXER cup (FlackTek, Incorporated, Landrum, S.C.): 75.0 grams of PSA 6574 and 8.4 grams of toluene. These were mixed at 2700 rpm for 45 seconds in a DAC 150.1 FVZ-K SPEEDMIXER (FlackTek, Incorporated, Landrum, S.C.). To this solution was added 1.06 grams of 20% Di (2,4-dichlorobenzoyl) peroxide solution, followed by mixing for an additional 45 seconds at 2700 rpm to give a homogenous solutions containing 50% (w:w) solids. This solution contained PSA6574-silicone:DCBPO/99.5:0.5 (w:w). This solution was coated by hand onto the release treated side of a fluorosilicone liner, SF 88001, using a notchbar coater having a gap setting of 0.006 inches (153 micrometers) greater than the thickness of the liner and a speed of 3 feet/minute (91 centimeters/minute). Solvent removal and crosslinking of the coated adhesive was carried out in the following manner. First, the coated liner was allowed to sit at room temperature for 10 minutes; next, it was attached to the top of a rectangular, metal frame such that the majority of the adhesive coated area was suspended above the frame and not in contact with it and the resulting assembly placed in an oven at 167° F. (75° C.) for ten minutes; and finally the assembly was placed in an oven at 347° F. (175° C.) for two minutes. An adhesive transfer tape having a crosslinked adhesive layer with a thickness of approximately 49 micrometers on a release liner was obtained.

### Comparative Example 18

A coating solution was prepared by adding the following materials to a MAX 40 SPEEDMIXER cup (FlackTek, Incorporated, Landrum, S.C.): 75.0 grams of PSA 6574 and 8.4 grams of toluene. These were mixed at 2700 rpm for 45 seconds in a DAC 150.1 FVZ-K SPEEDMIXER (FlackTek, Incorporated, Landrum, S.C.). To this solution was added 1.06 grams of 20% Di (2,4-dichlorobenzoyl) peroxide solution, followed by mixing for an additional 45 seconds at 2700 rpm to give a homogenous solutions containing 50% (w:w) solids. This solution contained PSA 6574-silicone:DCBPO/99.5:0.5 (w:w). To a new MAX 40 SPEEDMIXER cup was added 30.00 grams of this solution and 16.88 grams of toluene. These were mixed at 2700 rpm for 45 seconds in a DAC 150.1 FVZ-K SPEEDMIXER (FlackTek, Incorporated, Landrum, S.C.) to five a 32% solids homogeneous solution. The solution was coated by hand onto the release treated side of a fluorosilicone liner, SF 88001, using a notchbar coater having a gap setting of 0.002 inches (51 micrometers) greater than the thickness of the liner and a speed of 3 feet/minute (91 centimeters/minute). Solvent removal and crosslinking of the coated adhesive was carried out in the following manner. First, the coated liner was allowed to sit at room temperature for 10 minutes; next, it was attached to the top of a rectangular, metal frame such that the majority of the adhesive coated area was suspended above the frame and not in contact with it and the resulting assembly placed in an oven at 167° F. (75° C.) for ten minutes; and finally the assembly was placed in an oven at 347° F. (175° C.) for two minutes. An adhesive transfer tape having a crosslinked adhesive layer with a thickness of approximately 11 micrometers on a release liner was obtained.

### Comparative Example 19

Example 12 was repeated, but was not e-beamed.

### Comparative Example 20

Example 1 was repeated, but was e-beamed at 120 kV with 4 Mrad at 24.1 fpm under a nitrogen atmosphere.

### Comparative Example 21

Example 3 was repeated, but was not e-beamed.

### Comparative Example 22

Example 6 was repeated, but was not e-beamed.

### Comparative Example 23

Example 7 was repeated, but was not e-beamed.

### Comparative Example 24

To a 500 milliliter glass jar were added 200.0 grams of PSA 6574 and 183.0 grams of toluene. The jar was sealed and placed on a mechanical roller for one hour to give a 29.2% solids (w:w) solution. To this solution was added 66.7 grams of a freshly prepared 7% Benzoyl Peroxide Solution, made as described above. The jar was once again sealed and placed on a mechanical roller, this time for 15 minutes, to give a homogenous solutions containing 25.9% (w:w) solids. This solution contained PSA 6574:BPO/96:4 (w:w). This solution was coated onto the release treated side of a 13 inch (33 centimeters) wide fluorosilicone liner, SF 88001 using a notchbar coater having a gap setting of 0.004 inches (102 micrometers) greater than the thickness of the liner followed by passing the coated liner through an oven having three zones set at the following temperatures: 180° F., 180° F., and 300° F. (82° C., 82° C., and 149° C.) to remove solvent and crosslink the adhesive over a period of 4 minutes. A line speed of 9 feet/minute (2.74 meters/minute) was employed for the coating/drying/crosslinking process. The crosslinked adhesive surface of the resulting article was laminated to the release coated side of a second fluorosilicone liner, SF 82001, using a nip roller. An adhesive transfer tape having a crosslinked adhesive layer with a thickness of approximately 18 micrometers between two different release liners was obtained.

### Comparative Example 25

25.0 grams of PSA6574 solution was coated by hand onto the release treated side of a fluorosilicone liner, SF 88001, using a notchbar coater having a gap setting of 0.006 inches (156 micrometers) greater than the thickness of the liner and a speed of 3 feet/minute (91 centimeters/minute). Solvent removal of the coated adhesive was carried out in the following manner. First, the coated liner was allowed to sit at room temperature for 10 minutes; next, it was attached to the top of a rectangular, metal plate and the resulting assembly placed in an oven at 257° F. (125° C.) for ten minutes. An adhesive transfer tape having an adhesive layer with a thickness of approximately 50 micrometers on a release liner was obtained. The sample was e-beamed open face with 2.5 Mrad at 135 kV at 24.1 fpm under a nitrogen atmosphere.

### Comparative Example 26

Comparative Example 25 was repeated with the following modifications. The notchbar gap was 0.004 inches. The adhesive was 25.0 microns thick. The sample was e-beamed open face with 2.5 Mrad at 135 kV at 24.1 fpm under a nitrogen atmosphere.

### Comparative Example 27

PSA 6574 was coated onto the release treated side of a 13 inch (33 centimeters) wide fluorosilicone liner, SF 88001, using a notchbar coater having a gap setting of 0.0065 inches (165 micrometers) greater than the thickness of the liner followed by passing the coated liner through an oven having three zones set at the following temperatures: 176° F., 176° F., and 270° F. (80° C., 80° C., and 132° C.) to remove solvent over a period of 4 minutes. A line speed of 9 feet/minute (2.74 meters/minute) was employed for the coating/drying process. The adhesive surface of the resulting article was laminated to the release coated side of a second fluorosilicone liner, SF 82001, using a nip roller. An adhesive transfer tape having an adhesive layer with a thickness of approximately 50 micrometers between two different release liners was obtained. The SF 82001 liner was removed and adhesive was e-beamed open face with 6 Mrad, 300 kV at 24.1 fpm.

### Comparative Example 28

A coating solution was prepared by adding the following materials to a MAX 40 SPEEDMIXER cup (FlackTek, Incorporated, Landrum, S.C.): 2.02 grams of PSA 6574 and 18.01 g of 7956. These were mixed at 2700 rpm for 45 seconds in a DAC 150.1 FVZ-K SPEEDMIXER (FlackTek, Incorporated, Landrum, S.C.). To this solution was added 8.75 g toluene and the solution was mixed an additional 45 seconds at 2700 rpm. To this solution was added 4.11 grams of a freshly prepared 7% Benzoyl Peroxide Solution, made as described above followed by mixing for an additional 45 seconds at 2700 rpm to give a homogenous solutions containing 35% (w:w) solids. This solution contained PSA 6574:7956:BPO/9.75:87.75:2.5 (w:w:w). This solution was coated by hand onto the release treated side of a fluorosilicone liner, SF 88001, using a notchbar coater having a gap setting of 0.002 inches (51 micrometers) greater than the thickness of the liner and a speed of 3 feet/minute (91 centimeters/minute). Solvent removal and crosslinking of the coated adhesive was carried out in the following manner. First, the coated liner was allowed to sit at room temperature for 10 minutes; next, it was attached to the top of a rectangular, metal frame such that the majority of the adhesive coated area was suspended above the frame and not in contact with it and the resulting assembly placed in an oven at 201° F. (94° C.) for ten minutes; and finally the assembly was placed in an oven at 300° F. (149° C.) for three minutes. An adhesive transfer tape having a crosslinked adhesive layer with a thickness of approximately 11 micrometers on a release liner was obtained.

### Comparative Example 29

A coating solution was prepared by adding the following materials to a MAX 40 SPEEDMIXER cup (FlackTek, Incorporated, Landrum, S.C.): 3.50 grams of PSA 6574 and 14.03 g of 7956. These were mixed at 2700 rpm for 45 seconds in a DAC 150.1 FVZ-K SPEEDMIXER (FlackTek, Incorporated, Landrum, S.C.). To this solution was added 7.63 g toluene and the solution was mixed an additional 45 seconds at 2700 rpm. To this solution was added 3.59 grams of a freshly prepared 7% Benzoyl Peroxide Solution, made as described above followed by mixing for an additional 45 seconds at 2700 rpm to give a homogenous solutions containing 35% (w:w) solids. This solution contained PSA 6574:7956:BPO/19.5:78.0:2.5 (w:w:w). This solution was coated by hand onto the release treated side of a fluorosilicone liner, SF 88001, using a notchbar coater having a gap setting of 0.0025 inches (63 micrometers) greater than the thickness of the liner and a speed of 3 feet/minute (91 centimeters/minute). Solvent removal and crosslinking of the coated adhesive was carried out in the following manner. First, the coated liner was allowed to sit at room temperature for 10 minutes; next, it was attached to the top of a rectangular, metal frame such that the majority of the adhesive coated area was suspended above the frame and not in contact with it and the resulting assembly placed in an oven at 201° F. (94° C.) for ten minutes; and finally the assembly was placed in an oven at 320° F. (160° C.) for three minutes. An adhesive transfer tape having a crosslinked adhesive layer with a thickness of approximately 12 micrometers on a release liner was obtained.

### Example 18

To a 500 milliliter jar were added 100 grams of 88778 Gum and 300 grams of toluene. The jar was sealed and placed on a mechanical roller for 4 days to give a homogeneous 25.0% solids (w:w) solution. To a 1 gallon jar was added 280.0 grams of PSA 6574 and 150.1 grams of toluene. The jar was sealed and placed on a mechanical roller for 1 day to give a clear solution. To the 1 gallon jar was added 265.8 grams of the 25% solids Gum solution, as described above. The 1 gallon jar was once again sealed and placed on a mechanical roller, this time for 24 hours, to give a homogenous solutions containing 31.8% (w:w) solids and a 70:30 (w:w) ratio of PSA 6574:88778 Gum. To the 1 gallon jar was added 56.3 grams of 7% Benzoyl Peroxide solution to make a coating formulation containing PSA 6574: 88778 Gum: BPO/68.775:29.475:1.75 (w:w:w). This solution was coated onto the release treated side of a 13 inch (33 centimeters) wide SF 88001, using a notchbar coater having a gap setting of 0.004 inches (100 micrometers) greater than the thickness of the liner followed by passing the coated liner through an oven having three zones set at the following temperatures: 180° F., 180° F., and 300° F. (82° C., 82° C., and 149° C.) to remove solvent and crosslink the adhesive over a period of 4 minutes. A line speed of 9 feet/minute (2.74 meters/minute) was employed for the coating/drying/crosslinking process. The crosslinked adhesive surface of the resulting article was laminated to the release coated side of a second fluorosilicone liner, SF 82001, using a nip roller. An adhesive transfer tape having a crosslinked adhesive layer with a thickness of approximately 18 micrometers between two different release liners was obtained. The Shear Adhesion Strength at 70° C. with 1000 gram Weight test was performed promptly after the adhesive transfer tape was prepared, as it was observed that the adhesion built between the adhesive and the SF 82001 liner to the point where the adhesive substantially transferred to the SF 82001 over time.

### Example 19

To a 500 milliliter jar were added 100 grams of 88778 Gum and 300 grams of toluene. The jar was sealed and placed on a mechanical roller for 4 days to give a homogeneous 25.0% solids (w:w) solution.

A coating solution was prepared by adding the following materials to a MAX 40 SPEEDMIXER cup (FlackTek, Incorporated, Landrum, S.C.): 25.0 grams of PSA 6574 and 15.0 grams of toluene. These were mixed two times at 3200 rpm for 60 seconds (for a total of 120 seconds) in a DAC 150.1 FVZ-K SPEEDMIXER (FlackTek, Incorporated, Landrum, S.C.) to provide a clear solution. To this solution was added 23.76 grams of the 25.0% Gum in toluene and the solution was mixed two times at 60 seconds (for a total of 120 seconds) at 3000 rpm to give a thoroughly mixed solution containing 31% (w:w) solids. This solution contained PSA 6574:88778 Gum/70:30 (w:w). To the mixing cup was added 2.87 grams of 7% Benzoyl Peroxide in toluene and the solution was mixed two times at 60 seconds (for a total of 120 seconds) at 3000 rpm to make a 30% solids coating formulation containing PSA 6574:88778 Gum: BPO/69.30:29.70:1.00 (w:w:w).

This solution was coated by hand onto the release treated side of a fluorosilicone liner, SF 88001, using a notchbar coater having a gap setting of 0.008 inches (51 micrometers) greater than the thickness of the liner and a speed of 3 feet/minute (91 centimeters/minute). Solvent removal and crosslinking of the coated adhesive was carried out in the following manner. First, the coated liner was allowed to sit at room temperature for 5 minutes; next, it was attached to the top of a rectangular, metal frame such that the majority of the adhesive coated area was suspended above the frame and not in contact with it and the resulting assembly placed in an oven at 201° F. (94° C.) for five minutes; finally the adhesive in the frame was crosslinked by placing it in an oven at 300° F. (149° C.) for 3 minutes. A crosslinked adhesive layer with a thickness of approximately 34 micrometers (1.35 mil) on a release liner was obtained.

### Example 20

To a 500 milliliter jar were added 150.04 grams PSA 6574 (56% solids), 37.52 grams 7956, and 211.77 grams of toluene. The jar was sealed and placed on a mechanical roller for 24 hours. To the 500 milliliter jar was added 9.13 grams of PDM-1922 and the mixture was rolled for 24 hours to make a homogeneous solution at 27.9% solids in a weight ratio of PSA6574:7956:PDM-1922 of 73.6/18.4/8.0. To the jar was added 41.84 g solution of 7% Benzoyl Peroxide in toluene and the mixture was rolled for 50 min to make a coating formulation in a ratio of PSA 6574:7956: PDM-1922: BPO/71.76:17.94:7.80:2.50 (w:w:w:w).

This solution was coated onto the release treated side of a 13 inch (33 centimeters) wide SF 88001, using a notchbar coater having a gap setting of 0.003 inches (75 micrometers) greater than the thickness of the liner followed by passing the coated liner through an oven having three zones set at the following temperatures: 176° F., 176° F., and 300° F. (80° C., 80° C., and 149° C.) to remove solvent and crosslink the adhesive over a period of 4 minutes. A line speed of 9 feet/minute (2.74 meters/minute) was employed for the coating/drying/crosslinking process. The crosslinked adhesive surface of the resulting article was laminated to the release coated side of a second fluorosilicone liner, SF 82001, using a nip roller. An adhesive transfer tape having a crosslinked adhesive layer with a thickness of approximately 10 micrometers between two different release liners was obtained.

In the following tables, “CE” means Comparative Example and “Ex” means Example. Table I represents the polysiloxane content of the Examples and Comparative Examples. Percentages were weight percent based on total weight of polysiloxane.

TABLE I

| | | | | | | | | DC | Silicone | Silicone |
|---|---|---|---|---|---|---|---|---|---|---|
| | PSA | DC | PSA | Andisil | DC | 88778 | PDM- | Q2- | MQ | DPSi |
| Ex # | 6574 | 7956 | 518 | 1230 | 200 | Gum | 1922 | 7735 | content | Content |
| CE 1 | | | | | | | | 100.0% | 60.0% | 0.0% |
| CE 2 | | | | | | | | 100.0% | 60.0% | 0.0% |
| CE 3 | | | | | | | | 100.0% | 60.0% | 0.0% |
| CE 4 | | | | | | | | 100.0% | 60.0% | 0.0% |
| CE 5 | 100.0% | | | | | | | | 69.8% | 8.4% |
| CE 6 | 100.0% | | | | | | | | 69.8% | 8.4% |
| CE 7 | 100.0% | | | | | | | | 69.8% | 8.4% |
| CE 8 | 100.0% | | | | | | | | 69.8% | 8.4% |
| CE 9 | | | 100.0% | | | | | | 72.6% | 1.6% |
| CE 10 | | | 100.0% | | | | | | 72.6% | 1.6% |
| CE 11 | | | 100.0% | | | | | | 72.6% | 1.6% |
| CE 12 | | 100.0% | | | | | | | 64.4% | 1.8% |
| CE 13 | | 100.0% | | | | | | | 64.4% | 1.8% |
| CE 14 | | 100.0% | | | | | | | 64.4% | 1.8% |
| CE 15 | 100.0% | | | | | | | | 69.8% | 8.4% |
| CE 16 | 20.0% | 80.0% | | | | | | | 65.5% | 3.1% |
| CE 17 | 100.0% | | | | | | | | 69.8% | 8.4% |
| CE 18 | 100.0% | | | | | | | | 69.8% | 8.4% |
| CE 19 | 100.0% | | | | | | | | 69.8% | 8.4% |
| CE 20 | 100.0% | | | | | | | | 69.8% | 8.4% |
| CE 21 | 96.9% | | | | 3.1% | | | | 67.6% | 8.1% |
| CE 22 | 98.5% | 1.5% | | | | | | | 69.7% | 8.3% |
| CE 23 | 96.9% | 3.1% | | | | | | | 69.6% | 8.2% |
| CE 24 | 100.0% | | | | | | | | 69.8% | 8.4% |
| CE 25 | 100.0% | | | | | | | | 69.8% | 8.4% |
| CE 26 | 100.0% | | | | | | | | 69.8% | 8.4% |
| CE 27 | 100.0% | | | | | | | | 69.8% | 8.4% |
| CE 28 | 10.0% | 90.0% | | | | | | | 64.9% | 2.5% |
| CE 29 | 20.0% | 80.0% | | | | | | | 65.5% | 3.1% |
| Ex 1 | 100.0% | | | | | | | | 69.8% | 8.4% |
| Ex 2 | 100.0% | | | | | | | | 69.8% | 8.4% |
| Ex 3 | 96.9% | | | | 3.1% | | | | 67.6% | 8.1% |
| Ex 4 | 100.0% | | | | | | | | 69.8% | 8.4% |
| Ex 5 | 100.0% | | | | | | | | 69.8% | 8.4% |
| Ex 6 | 98.5% | 1.5% | | | | | | | 69.7% | 8.3% |
| Ex 7 | 96.9% | 3.1% | | | | | | | 69.6% | 8.2% |
| Ex 8 | 96.6% | | | | 3.4% | | | | 67.4% | 8.1% |
| Ex 9 | 96.6% | 3.4% | | | | | | | 69.6% | 8.2% |
| Ex 10 | 20.0% | 80.0% | | | | | | | 65.5% | 3.1% |
| Ex 11 | 20.0% | 80.0% | | | | | | | 65.5% | 3.1% |
| Ex 12 | 100.0% | | | | | | | | 69.8% | 8.4% |
| Ex 13 | 100.0% | | | | | | | | 69.8% | 8.4% |
| Ex 14 | 80.0% | 20.0% | | | | | | | 68.7% | 7.1% |
| Ex 15 | 100.0% | | | | | | | | 69.8% | 8.4% |
| Ex 16 | 100.0% | | | | | | | | 69.8% | 8.4% |
| Ex 17 | 96.0% | | | 4.0% | | | | | 67.0% | 9.2% |
| Ex 18 | 70% | | | | | 30% | | | 48.9% | 14.5% |
| Ex 19 | 70% | | | | | 30% | | | 48.9% | 14.5% |
| Ex 20 | 73.6% | 18.4% | | | | | 8.0% | | 63.2% | 9.7% |

Table II represents the crosslinking conditions of the Examples and Comparative Examples. For Examples or Comparative Examples that were crosslinked with e-beam radiation, e-beam conditions are provided. For Examples or Comparative Examples that were crosslinked with peroxide, peroxide crosslinking conditions are provided. For Comparative Examples that were not crosslinked, no e-beam or peroxide crosslinking conditions are provided. In the case of Examples or Comparative Examples that were crosslinked with e-beam radiation, some were irradiated open face and some through a covering liner, as indicated. Peroxide percentages were weight percent based on total weight of polysiloxane plus peroxide. L1 was the liner on which the film was cast. L2 was the liner laminated over the cast film, if any; or, in some cases, a PEEK film was laminated over the cast film.

TABLE II

| | Film | | | E-Beam | E-Beam | E-Beam | | xlink | xlink |
|---|---|---|---|---|---|---|---|---|---|
| | Thickness | | | dose | Voltage | open/thru | % | temp | time |
| Ex # | (μm) | L1 | L2 | (Mrad) | (kV) | liner | peroxide | (° C.) | (min) |
| CE 1 | 41 | SF 88001 | none | | | | | | |
| CE 2 | 15 | SF 88001 | SF 82001 | | | | 3 | 149 | 2 |
| CE 3 | 41 | SF 88001 | none | 4 | 240 | open | | | |
| CE 4 | 41 | SF 88001 | none | 8 | 240 | open | | | |
| CE 5 | 16 | 5192 | SF 82001 | | | | | | |
| CE 6 | 16 | 5192 | none | 7 | 240 | open | | | |
| CE 7 | 11 | 5192 | SF 82001 | | | | 2 | 149 | 2 |
| CE 8 | 11 | 5192 | SF 82001 | | | | 2 | 177 | 2 |
| CE 9 | 18 | SF 88001 | none | | | | 2.5 | 160 | 5 |
| CE 10 | 16 | SF 88001 | none | | | | | | |
| CE 11 | 16 | SF 88001 | none | 3 | 240 | open | | | |
| CE 12 | 14 | 5192 | SF 82001 | | | | | | |
| CE 13 | 14 | 5192 | SF 82001 | 3 | 240 | thru L2 | | | |
| CE 14 | 13 | 5104 | 1022 | | | | 2.5 | 150 | 2 |
| CE 15 | 12 | 5192 | SF 82001 | 6 | 240 | open | | | |
| CE 16 | 11 | SF 88001 | PEEK | | | | | | |
| CE 17 | 49 | SF 88001 | none | | | | 0.5 | 175 | 2 |
| CE 18 | 11 | SF 88001 | none | | | | 0.5 | 175 | 2 |
| CE 19 | 11 | SF 82001 | PEEK | | | | | | |
| CE 20 | 12 | 5192 | SF 82001 | 4 | 120 | thru L2 | | | |
| CE 21 | 12 | 5192 | SF 82001 | | | | | | |
| CE 22 | 12 | 5192 | SF 82001 | | | | | | |
| CE 23 | 12 | 5192 | SF 82001 | | | | | | |
| CE 24 | 18 | SF 88001 | SF 82001 | | | | 4 | 149 | 2 |
| CE 25 | 50 | SF 88001 | none | 2.5 | 135 | open | | | |
| CE 26 | 25 | SF 88001 | none | 2.5 | 135 | open | | | |
| CE 27 | 50 | SF 88001 | SF 82001 | 6 | 300 | open | | | |
| CE 28 | 11 | SF 88001 | none | | | | 2.5 | 149 | 3 |
| CE 29 | 12 | SF 88001 | none | | | | 2.5 | 160 | 3 |
| Ex 1 | 12 | 5192 | SF 82001 | 3 | 240 | thru L2 | | | |
| Ex 2 | 12 | 5192 | SF 82001 | 3.5 | 240 | thru L2 | | | |
| Ex 3 | 12 | 5192 | SF 82001 | 3 | 240 | thru L2 | | | |
| Ex 4 | 12 | 5192 | SF 82001 | 3 | 240 | thru L2 | | | |
| Ex 5 | 12 | 5192 | SF 82001 | 3 | 240 | open | | | |
| Ex 6 | 12 | 5192 | SF 82001 | 3 | 240 | thru L2 | | | |
| Ex 7 | 12 | 5192 | SF 82001 | 3 | 240 | thru L2 | | | |
| Ex 8 | 12 | 5192 | 1022 | | | | 2.1 | 150 | 2 |
| Ex 9 | 12 | 5192 | 1022 | | | | 2.1 | 150 | 2 |
| Ex 10 | 12 | SF 88001 | SF 82001 | 3 | 240 | thru L2 | | | |
| Ex 11 | 11 | SF 88001 | PEEK | 3 | 240 | thru L1 | | | |
| Ex 12 | 11 | SF 82001 | PEEK | 3 | 240 | open | | | |
| Ex 13 | 13 | SF 88001 | SF 82001 | | | | 3 | 149 | 2 |
| Ex 14 | 16 | 5192 | SF 82001 | | | | 2.5 | 149 | 2 |
| Ex 15 | 8 | SF 88001 | SF 82001 | 2.00 | 240.00 | thru L2 | | | |
| Ex 16 | 16 | SF 88001 | SF 82001 | 2.00 | 240.00 | thru L2 | | | |
| Ex 17 | 14 | SF 88001 | SF 82001 | | | | 2.5 | 149 | 2 |
| Ex 18 | 20 | SF 88001 | SF 82001 | | | | 1.75 | 149 | 2 |
| Ex 19 | 35 | SF 88001 | | | | | 1.0 | 149 | 2 |
| Ex 20 | 10 | SF 88001 | SF 82001 | | | | 2.5 | 149 | 2 |

Table III represents shear test results, measured as described above. Results are reported in minutes. Not all Comparative Examples were tested.

TABLE III

| | 1 kg 70° C. | 500 g 70° C. |
|---|---|---|
| | Shear test | Shear test |
| Ex # | PET (min) | PEEK (min) |
| CE 2 | >10,000 | |
| CE 5 | 19 | |
| CE 6 | 4183 | |
| CE 8 | 3006.5 | |
| CE 14 | >10,000 | |
| CE 15 | >10,000 | |
| CE 16 | | 35 |
| CE 19 | | 397 |
| CE 20 | 51 | 250 |
| CE 24 | >10,000 | |
| CE 25 | 2428 | |
| CE 26 | 1512 | |
| CE 28 | 7417 | |
| Ex 1 | 6118 | |
| Ex 2 | >10,000 | |
| Ex 3 | >10,000 | |
| Ex 4 | >10,000 | |
| Ex 5 | >10,000 | >10,000 |
| Ex 6 | >10,000 | |
| Ex 7 | >10,000 | |
| Ex 8 | >10,000 | |
| Ex 9 | >10,000 | |
| Ex 10 | >10,000 | >10,000 |
| Ex 11 | | 6138 |
| Ex 12 | | >10,000 |
| Ex 13 | >10,000 | |
| Ex 14 | >10,000 | |
| Ex 15 | >10,000 | |
| Ex 16 | >10,000 | |
| Ex 17 | >10,000 | |
| Ex 18 | >10,000 | |
| Ex 19 | >10,000 | |
| Ex 20 | >10,000 | |

Table IV represents results of dynamic mechanical analysis testing. Not all Comparative Examples and Examples were tested. The minimum tan delta (between 20° C. and 250° C.) was recorded and is reported, along with the temperature at which the minimum occurred. G′ min is the G′ at the temperature of minimum tan delta. Tan delta was also recorded and is reported at each of 25° C., 200° C., 250° C., and in some cases at −40° C.

TABLE IV

| | Tg | | | | | Tan | | | | | |
|---|---|---|---|---|---|---|---|---|---|---|---|
| | (tan | G′ | | G′ | Tan | delta | G′ | Tan | G′ | Tan | |
| | delta | 25° C. | Tan | min | delta | min | 200° C. | delta | 250° C. | delta | Tan |
| Ex # | max) | (Pa) | delta 25° C. | (Pa) | min | temp ° C. | (Pa) | 200° C. | (Pa) | 250° C. | delta −40° C. |
| CE 1 | 40.6 | 7.95E5 | 0.99 | 2.42E4 | 0.48 | 119 | 4057 | 1.47 | 126 | 2.90 | 0.21 |
| CE 2 | 33.5 | 4.43E5 | 1.01 | 2.50E4 | 0.35 | 163 | 2.49E4 | 0.37 | 9826 | 0.55 | ND |
| CE 3 | 30.5 | 2.59E5 | 1.16 | 1.95E4 | 0.36 | 148 | 10312 | 0.59 | 1305 | 1.43 | ND |
| CE 4 | 33.5 | 3.67E5 | 1.05 | 2.03E4 | 0.29 | 175 | 17305 | 0.32 | 8241 | 0.41 | ND |
| CE 5 | 37.5 | 8.73E5 | 1.16 | 2.58E4 | 0.84 | 130 | 2.4E4 | 1.13 | 1.35E4 | 1.86 | ND |
| CE 6 | 39.5 | 4.65E5 | 1.07 | 8796 | 0.26 | 250 | 12047 | 0.31 | 8796 | 0.26 | ND |
| CE 7 | 42.5 | 6.50E5 | 1.23 | 2.02E4 | 0.60 | 169 | 15385 | 0.63 | 4970 | 0.88 | ND |
| CE 8 | 45.6 | 7.02E5 | 1.16 | 1.79E4 | 0.51 | 162 | 12576 | 0.6 | 4393 | 0.89 | ND |
| CE 9 | 15.3 | 4.67E4 | 1.23 | 1.92E4 | 0.35 | 106 | 14673 | 0.39 | 8584 | 0.51 | ND |
| CE 10 | 12.2 | 7.28E4 | 1.21 | 1.8E4 | 0.62 | 66 | 4126 | 1.14 | 1679 | 1.85 | ND |
| CE 11 | 6.2 | 5.02E4 | 1.04 | 1.56E4 | 0.30 | 172 | 14212 | 0.31 | 10779 | 0.35 | ND |
| CE 12 | 3.2 | 6.58E4 | 0.91 | 9186 | 0.42 | 81 | 4912 | 1.05 | 1960 | 1.79 | 0.42 |
| CE 13 | 1.3 | 4.04E4 | 0.81 | 1.74E4 | 0.37 | 131 | 13287 | 0.42 | 10843 | 0.42 | 0.43 |
| CE 14 | 6.1 | 4.35E4 | 0.88 | 1.99E4 | 0.37 | 103 | 17671 | 0.39 | 10754 | 0.51 | ND |
| CE 15 | 39.5 | 5.40E5 | 1.18 | 1.15E4 | 0.36 | 244 | 13759 | 0.38 | 11002 | 0.37 | ND |
| CE 17 | 30.5 | 4.99E5 | 1.34 | 1.47E4 | 0.51 | 154 | 1.12E4 | 0.69 | 4615 | 0.97 | ND |
| CE 18 | 39.5 | 5.42E5 | 1.18 | 2.40E4 | 0.63 | 145 | 1.73E4 | 0.73 | 7631 | 1.24 | ND |
| CE 20 | 45.5 | 5.40E5 | 1.28 | 9787 | 0.82 | 134 | 5038 | 1.07 | 2744 | 1.25 | ND |
| CE 21 | 36.5 | 3.47E5 | 1.23 | 3.62E4 | 0.78 | 106 | 3.54E4 | 1.17 | 2.30E4 | 1.73 | ND |
| CE 22 | 45.5 | 5.57E5 | 1.22 | 2.31E4 | 0.85 | 121 | 2.14E4 | 1.22 | 1.06E4 | 2.19 | ND |
| CE 23 | 45.5 | 4.95E5 | 1.15 | 1.40E4 | 0.84 | 121 | 1.24E4 | 1.23 | 4294 | 2.00 | ND |
| CE 24 | 30.5 | 2.93E5 | 1.28 | 1.75E4 | 0.31 | 211 | 1.86E4 | 0.32 | 11183 | 0.38 | ND |
| CE 25 | 45.5 | 6.70E5 | 1.14 | 1.70E4 | 0.62 | 160 | 1.72E4 | 0.73 | 15040 | 0.96 | ND |
| CE 26 | 33.4 | 1.41E5 | 1.29 | 1.19E4 | 0.58 | 148 | 9183 | 0.67 | 6531 | 0.86 | ND |
| CE 27 | 30.4 | 2.14E5 | 1.28 | 6926 | 0.36 | 235 | 8015 | 0.39 | 6391 | 0.36 | ND |
| CE 28 | 7.3 | 4.57E4 | 1.01 | 2.49E4 | 0.49 | 88 | 14529 | 0.59 | 5333 | 0.88 | 0.38 |
| CE 29 | 18.4 | 8.84E4 | 1.13 | 1.44E4 | 0.48 | 154 | 10159 | 0.65 | 4570 | 0.89 | ND |
| Ex 1 | 42.5 | 4.05E5 | 1.27 | 1.34E4 | 0.57 | 175 | 11284 | 0.63 | 6555 | 0.69 | ND |
| Ex 2 | 42.5 | 5.95E5 | 1.29 | 1.97E4 | 0.50 | 168 | 14488 | 0.55 | 8782 | 0.61 | ND |
| Ex 3 | 31.4 | 1.65E5 | 1.32 | 1.54E4 | 0.56 | 157 | 12494 | 0.62 | 8403 | 0.71 | 0.27 |
| Ex 4 | 39.5 | 3.55E5 | 1.27 | 1.48E4 | 0.50 | 151 | 10804 | 0.58 | 7508 | 0.68 | ND |
| Ex 5 | 42.5 | 3.00E5 | 1.21 | 1.13E4 | 0.51 | 151 | 7832 | 0.57 | 6060 | 0.59 | ND |
| Ex 6 | 42.5 | 3.17E5 | 1.26 | 1.32E4 | 0.59 | 151 | 9491 | 0.67 | 6477 | 0.78 | ND |
| Ex 7 | 39.5 | 4.49E5 | 1.31 | 1.62E4 | 0.57 | 142 | 9563 | 0.60 | 6109 | 0.65 | ND |
| Ex 8 | 36.5 | 2.12E5 | 1.19 | 1.49E4 | 0.62 | 151 | 11102 | 0.68 | 6185 | 0.84 | ND |
| Ex 9 | 36.5 | 3.21E5 | 1.23 | 1.96E4 | 0.55 | 139 | 15106 | 0.59 | 5978 | 0.69 | ND |
| Ex 10 | 6.2 | 9.97E4 | 0.99 | 1.43E4 | 0.55 | 201 | 14400 | 0.55 | 9413 | 0.62 | ND |
| Ex 13 | 45.5 | 7.22E5 | 1.04 | 1.17E4 | 0.54 | 168 | 9429 | 0.54 | 4786 | 0.72 | ND |
| Ex 14 | 9.3 | 1.59E5 | 0.90 | 3.8E4 | 0.54 | 76 | 9752 | 0.55 | 5113 | 0.64 | 0.28 |
| Ex 15 | 30.5 | 1.85E5 | 1.43 | 1.26E4 | 0.50 | 172 | 11248 | 0.54 | 8072 | 0.59 | ND |
| Ex 16 | 30.3 | 1.58E5 | 1.42 | 1.43E4 | 0.52 | 142 | 11900 | 0.58 | 9900 | 0.61 | ND |
| Ex 17 | 21.3 | 9.40E4 | 1.36 | 9494 | 0.46 | 160 | 7914 | 0.47 | 5015 | 0.56 | 0.31 |
| Ex 18 | −36 | 3.81E4 | 0.46 | 3.31E4 | 0.45 | 49 | 23197 | 0.47 | 18434 | 0.52 | 0.97 |
| Ex 19 | −36 | 3.93E4 | 0.44 | 2.73E4 | 0.43 | 67 | 21369 | 0.45 | 16838 | 0.52 | 0.99 |
| Ex 20 | −8 | 4.56E4 | 0.66 | 2.52E4 | 0.58 | 56 | 7920 | 0.66 | 3144 | 0.90 | 0.50 |

ND = Not Determined

Table V reports the difference between the minimum tan delta (between 20° C. and 200° C.) and the tan delta measured at 200° C. (“ΔT.D. from minimum to 200° C.”), and the difference between the minimum tan delta (between 20° C. and 250° C.) and the tan delta measured at 250° C. (“ΔT.D. from minimum to 250° C.”). Not all Comparative Examples and Examples were tested.

TABLE V

| | ΔT.D. from | ΔT.D. from |
|---|---|---|
| | minimum to | minimum to |
| Ex # | 200° C. | 250° C. |
| CE 1 | 0.99 | 2.42 |
| CE 2 | 0.02 | 0.20 |
| CE 3 | 0.23 | 1.07 |
| CE 4 | 0.03 | 0.12 |
| CE 5 | 0.29 | 1.02 |
| CE 6 | 0.05 | 0.00 |
| CE 7 | 0.03 | 0.28 |
| CE 8 | 0.09 | 0.38 |
| CE 9 | 0.04 | 0.16 |
| CE 10 | 0.52 | 1.23 |
| CE 11 | 0.01 | 0.05 |
| CE 12 | 0.63 | 1.37 |
| CE 13 | 0.05 | 0.05 |
| CE 14 | 0.02 | 0.14 |
| CE 15 | 0.02 | 0.01 |
| CE 17 | 0.18 | 0.46 |
| CE 18 | 0.10 | 0.61 |
| CE 20 | 0.25 | 0.43 |
| CE 21 | 0.39 | 0.95 |
| CE 22 | 0.37 | 1.34 |
| CE 23 | 0.39 | 1.16 |
| CE 24 | 0.01 | 0.07 |
| CE 25 | 0.11 | 0.34 |
| CE 26 | 0.09 | 0.28 |
| CE 27 | 0.02 | 0.02 |
| CE 28 | 0.10 | 0.39 |
| CE 29 | 0.17 | 0.41 |
| Ex 1 | 0.06 | 0.12 |
| Ex 2 | 0.05 | 0.11 |
| Ex 3 | 0.06 | 0.15 |
| Ex 4 | 0.07 | 0.18 |
| Ex 5 | 0.06 | 0.08 |
| Ex 6 | 0.08 | 0.19 |
| Ex 7 | 0.03 | 0.08 |
| Ex 8 | 0.06 | 0.22 |
| Ex 9 | 0.04 | 0.14 |
| Ex 10 | 0.00 | 0.07 |
| Ex 13 | 0.00 | 0.18 |
| Ex 14 | 0.01 | 0.10 |
| Ex 15 | 0.04 | 0.09 |
| Ex 16 | 0.06 | 0.09 |
| Ex 17 | 0.01 | 0.10 |
| Ex 18 | 0.01 | 0.07 |
| Ex 19 | 0.02 | 0.09 |
| Ex 20 | 0.08 | 0.45 |

Various modifications and alterations of this disclosure will become apparent to those skilled in the art without departing from the scope and principles of this disclosure, and it should be understood that this disclosure is not to be unduly limited to the illustrative embodiments set forth hereinabove.

1. A film having a thickness of at least 4 microns and less than 60 microns comprising a damping adhesive which comprises a polysiloxane or mixture of polysiloxanes, wherein the damping adhesive exhibits a tan delta of at least 0.42 for every temperature between 20° C. and 250° C., and wherein the damping adhesive exhibits a tan delta at 250° C. that is no more than 0.20 greater than the minimum tan delta measured in the range of 20° C. to 250° C.

2. The film according to claim 1 wherein the damping adhesive exhibits a tan delta at 250° C. that is no more than 0.13 greater than the minimum tan delta measured in the range of 20° C. to 250° C.

3. The film according to claim 1 wherein the damping adhesive exhibits a tan delta at 200° C. that is no more than 0.08 greater than the minimum tan delta measured in the range of 20° C. to 200° C.

4. A film having a thickness of at least 4 microns and less than 60 microns comprising a damping adhesive which comprises a polysiloxane or mixture of polysiloxanes, wherein the damping adhesive exhibits a tan delta of at least 0.42 for every temperature between 20° C. and 200° C., and wherein the damping adhesive exhibits a tan delta at 200° C. that is no more than 0.08 greater than the minimum tan delta measured in the range of 20° C. to 200° C.

5. The film according to claim 1 wherein the damping adhesive exhibits a tan delta at 200° C. that is no more than 0.05 greater than the minimum tan delta measured in the range of 20° C. to 200° C.

6. (canceled)

7. (canceled)

8. (canceled)

9. The film according to claim 8 wherein the peroxide crosslinking agent is benzoyl peroxide.

10-11. (canceled)

12. The film according to claim 1 wherein the polysiloxane(s) include:
5-35 wt % (based on total weight of polysiloxane(s)) of dimethylsiloxane units according to the formula —Si(Me)₂—O—.

13. The film according to claim 1 wherein the polysiloxane(s) include:
64-76 combined wt % (based on total weight of polysiloxane(s)) of M and Q units.

14. The film according to claim 1, wherein the damping adhesive exhibits a tan delta of at least 0.48 for every temperature between 20° C. and 250° C.

15. The film according to claim 1, wherein the damping adhesive exhibits a tan delta of at least 0.30 at −40° C.

16. (canceled)

17. The film according to claim 1 film having a thickness of greater than 5 microns and less than 45 microns.

18. A microspeaker diaphragm material comprising two or more stiff layers and at least one damping layer, wherein the damping layer is the film according to claim 1, and wherein each face of each damping layer is directly bound to a stiff layer.

19. A subassembly for manufacture of a microspeaker diaphragm material comprising a stiff layer and a damping layer, wherein the damping layer is the film according to claim 1, and wherein a first face of the damping layer is directly bound to the stiff layer.

20. A transfer tape comprising the film according to claim 1, wherein a first face of the film bears a liner layer.

21. A film having a thickness of at least 4 microns and less than 45 microns comprising a damping adhesive, obtained by crosslinking polysiloxane(s) by exposing the polysiloxane(s) in the form of a polysiloxane film having a thickness of greater than 5 microns and less than 45 microns to e-beam radiation or peroxide, wherein polysiloxane(s) means a polysiloxane or mixture of polysiloxanes, and wherein the polysiloxane(s) include:
40-80 combined wt % (based on total weight of polysiloxane(s)) of M and Q units, and
2.8-20 wt % (based on total weight of polysiloxane(s)) of diphenylsiloxane units according to the formula —Si(Ph)₂—O—.
